(19) United States
(12) Patent Application Publication
(10) Pub. No.: US 2010/0328320 A1
(43) Pub. Date: Dec. 30, 2010

(54) MEDICAL INFORMATION MANAGEMENT IN A PATIENT INFORMATION HUB SYSTEM

(76) Inventors: Jürgen Kerstna, Hasselby (SE); Patrik Malmberg, Stockholm (SE)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/373,563

(22) PCT Filed: Jul. 13, 2006
(86) PCT No.: PCT/SE2006/000884

§ 371 Date: Apr. 29, 2010

(51) Int. Cl. G06T 1/00; G06Q 50/00; G06F 19/00; G06F 3/048

(52) U.S. Cl. 345/501; 705/3; 705/51; 715/764

(57) ABSTRACT

A patient information hub (PIH) system used in a healthcare system for the management of data documents of a patient has an implanted medical device, and a portable non-implanted unit having the capability for communicating with the IMD. The PIH system stores and manages a document list containing information of data documents of the patient and information of in which data depositories of the healthcare system the documents are stored and can be retrieved from. The retrieval of the document list from the PIH system for display on a screen of the communicating unit or transmission to an external requesting unit is made dependent on a communication operation involving the IMD and the non-implanted unit.

### BACKGROUND OF THE INVENTION

1. Field of the Invention

The present invention generally relates to information management in a healthcare system, and in particular to patient-centered management of medical data documents in such a system.

2. Description of the Prior Art

The healthcare systems of today contain a vast number of different healthcare facilities and care providers distributed in different countries, regions of a country and at different hospitals and clinical departments throughout the world. Each such healthcare facility comprises and manages medical patient records containing medical data of the patients visiting the facility. Today patients are much more mobile than previously in terms of visiting different clinicians at different healthcare facilities. This has the consequence that the complete medical history of a patient is most often distributed among document depositories of multiple healthcare facilities and providers.

When a patient comes to visit a healthcare facility, the clinician often needs to lookup information from previous treatments. These previous treatments may, however, have taken place at different places and have been performed by different clinicians. The current healthcare facility will then only have access to a portion of the patient's total medical record and the clinician must therefore try to obtain the missing data from other healthcare providers.

More often than not, it is impossible for the clinician to have access to the full patient record without missing documents, even if they are digitally stored in different electronic medical journals or health record systems. There is no overview for the clinician of what has happened to the patient, other than that the patient is able to tell or his/her registered information in the current hospital. Inability to link medical data belonging to a patient is one of the big problems that holds back healthcare system integration and provision of the full patient medical history to the clinician. It adds cost to the healthcare service because the acquisition of the information takes a lot of time and effort from not only the current clinician but also from other healthcare providers who possess the required information.

In order to solve these problems, Integrating the Healthcare Enterprise (IHE) has defined the specifications called Technical Framework [1] Integrating the Healthcare Enterprise (IHE), IT Infrastructure, Technical Framework, Volume 1 (ITI TF-1), Integration Profiles, Revision 2.0, Aug. 15, 2005, [2] Integrating the Healthcare Enterprise (IHE), IT Infrastructure, Technical Framework, Volume 2 (ITI TF-2), Transactions, Revision 2.0, Aug. 15, 2005, to promote the integration of information systems that support modern healthcare institutions. Its fundamental objective is to ensure that in the care of patients all required information for medical decisions is accurate and available to healthcare professionals. For example, the Technical Framework defines how patient identity can be cross-referenced between different countries, hospitals and other types of healthcare-affinity domains. The IHE has provided several integration profiles, such as Patient Identifier Cross-referencing (PIX) and Cross-Enterprise Document Sharing (XDS), which primarily address the need of patient document sharing across different healthcare facilities. These prior art IHE XDS and PIX profiles can be used for defining how medical documents are shared and accessed cross different document depositories (healthcare facilities) and how patient identity mapping is performed so that a patient is associated with correct medical documents in different depositories.

The prior art solution is based on dividing the healthcare systems among different affinity domains, each containing a document registry which is a common place where information about document existence and their location is stored for the patients that belong to this affinity domain. Such an affinity domain could then constitute a country, a city, an administration region, a group of hospitals/clinics, an individual healthcare facility, a device manufacturer producing implantable medical devices or a national organization that unifies professionals in certain clinical fields. Each such document registry should then store information of the different medical documents collected within the affinity domain for its patients and found in one of the (multiple) depositories in the domain. A patient affinity domain preferably has certain common policies regarding how patients are identified, how consent is obtained and how access is controlled, as well as the format, content, structure, organization and representation of clinical information. Note, though, that these policies are not universal but only domain-specific. Therefore, the suggested integration profiles and medical data management becomes limited to the facilities of one domain and no common inter-domain integration profiles or inter-domain data management typically exist.

The prior art approach is marred by several drawbacks and shortcomings. Firstly, the suggested prior art technique is based on an organization that has one centralized documentation manager and registry per affinity domain. This means that for one and the same patient, multiple registries in different affinity domains can include documentation and location information necessary for access the full patient records. However, the prior art IHE solutions are mainly directed to intra- and not inter-domain interrogations and exchange of medical data documents. As a consequence, the clinicians become limited to what the patient himself/herself recalls of previous treatments taking place in other affinity domains. There is also a question of who should take the role as the central registry and manager for all patients and healthcare facilities per affinity domain. There is no clear candidate for these centralized roles. In addition, it becomes difficult to assure protection and security of sensitive patient data and documentation because responsibility is distributed in the affinity domain and cross domains. The prior art organization of healthcare and patient information management is further, due to its domain-centralization, mainly designed for handling gaps in the patient medical history. These gaps may arise when medical documents are requested by a clinician who belongs to a current affinity domain where the patient is being treated and the patient has previously been treated by another clinician outside the affinity domain.

### SUMMARY OF THE INVENTION

The present invention overcomes these and other drawbacks of the prior art arrangements.

It is a general object of the present invention to provide an efficient medical data management in a healthcare system.

It is another object of the invention to provide a patient-centered management of medical data generated for the patient in a healthcare system.

It is a further object of the invention to provide a medical data management for patients with implantable medical devices.

Yet another object of the invention is to provide a solution for facilitating integration and access of medical data documents of a patient stored in different data depositories in a healthcare system.

Briefly, the present invention involves a patient-centered management of medical data documents generated for the patient in a healthcare system and stored at different data depositories or repositories and healthcare providers in the system. The present invention teaches a patient information hub (PIH) system that includes an implantable medical device (IMD) of the patient together with a portable non-implanted unit adapted for conducting communication with the IMD. This non-implanted unit, for example, can be in the form of a Personal Digital Assistance, mobile telephone or laptop assigned to the IMD patient.

The PIH system has a memory, implemented in the IMD, non-implanted unit or distributed among the IMD and non-implanted unit, for storing a document list of the patient. This document list includes i) information of medical documents associated with the patient and/or the IMD generated at different healthcare providers in the healthcare system and collectively forming the total medical data record of the patient. The list further includes ii) information of where the different medical documents are stored in the healthcare system, i.e. identifiers of the different depositories containing documents of that patient. The list could also include additional metadata facilitating identification of a desired document from the list.

A physician in the healthcare system that would like to view a document of the patient generated by another physician and stored at another healthcare facility, compiles and sends a list query to the non-implanted unit. The non-implanted unit initiates a communication operation involving itself and the IMD for the purpose of retrieving the document list from the memory. This means that the list provision is made, according to the present invention, dependent on a correct communication between the IMD and the non-implanted unit.

In a first embodiment, the document list is stored in the IMD. This means that the communication operation involves, transmitting a list request from the non-implanted unit (upon reception of the list query) to the IMD, retrieval of a copy of the document list from the IMD memory and forwarding the list copy from the IMD to the non-implanted unit. If the requesting physician is present, the information of the list copy can be displayed on a display screen of the non-implanted unit. Otherwise the list is transmitted, such as over a radio-based communications network, to the physician's workstation for display thereon.

In a second embodiment, the list is stored in encrypted form on the non-implanted unit. Once a list query has been provided in the unit, it compiles and sends a decryption key request to the IMD. The requested decryption is stored or generated on the fly in the IMD and will be returned to the non-implanted unit. The encrypted list representation is decrypted by means of the received key to provide the list in a readable and transient form. It can then be displayed or transmitted to a remote unit as previously mentioned. After the session, the list in readable form is removed from the non-implanted unit.

Instead of displaying or returning the complete list, the PIH system can use search criteria included in the list query for performing a search among the entries in the document list, typically among the metadata found in the list. Only those entries fulfilling the search criteria would then be displayed or transmitted.

In a typical scenario, the patient brings the non-implanted unit to the physician during a visit in a healthcare facility (the IMD is of course also brought along since it is implanted in the patient). During the visit the physician connects (wired or wireless) the non-implanted unit to his/her workstation and thereby the local network of the facility. The physician uses the workstation and compiles a list query to the non-implanted unit of the PIH system to access the list of documents of this patient. Exchange of security attributes may take place to authenticate the two connecting devices. The non-implanted unit and the IMD trigger the communication operation, provide the list and send it to the workstation. The physician can review the list and identify a desired document. In a typical scenario, this document can be accessed simply by clicking on a link (URI) of the list for the document, which connects the workstation with the depository in which the document is stored. Possible security attributes for accessing the depository can be requested from the PIH system.

Before the visit is ended, the local depository of the healthcare facility could register new documents generated for the patient during the visit. The document list in the PIH system will therefore be updated with information (name and location) of these new documents.

The Invention Offers the Following Advantages:
Facilitates the management, integration and access of medical data documents in a healthcare system;
Provides a centralized, patient-specific system having all information and data required for exchanging and retrieving medical documents between and from different care providers in a healthcare system;
Unauthorized access to patient data is avoided since the patient controls access rights to his/her medical data record;
Assures protection and security of patient data information since responsibility becomes centralized and patient-centered and not distributed among different healthcare actors;
Prevents unauthorized access to sensitive document list even if part of the PIH system falls in the hand of a malicious person;
Existing standards and healthcare infrastructures can be re-used; and
Provides a flexible solution, where the PIH system can have different roles in the data management, including document registry, document source, document depository and document consumer.

Other advantages offered by the present invention will be appreciated upon reading of the below description of the embodiments of the invention.

### BRIEF DESCRIPTION OF THE DRAWINGS

FIG. 1 is a schematic overview of a patient information hub system according to an embodiment of the present invention.

FIG. 2 is a flow diagram of a data management method according to an embodiment of the present invention.

FIG. 3 is a flow diagram illustrating an additional step of the data management method of FIG. 2.

FIG. 4 is a flow diagram illustrating an additional step of the data management method of FIG. 2.

FIG. 5 is a schematic overview of a patient information hub system conducting communication with an external interrogating unit according to an embodiment of the present invention.

FIG. 6 is a schematic overview of a patient information hub system conducting communication with an external interrogating unit according to another embodiment of the present invention.

FIG. 7 is a schematic overview of a patient information hub system conducting communication with an external interrogating unit according to a further embodiment of the present invention.

FIG. 8 is a flow diagram illustrating the performing and retrieving step of FIG. 2 in more detail according to an embodiment of the present invention.

FIG. 9 is a flow diagram illustrating the performing and retrieving step of FIG. 2 in more detail according to another embodiment of the present invention.

FIG. 10 is a flow diagram illustrating additional steps of the data management method of FIG. 2.

FIG. 11 is a flow diagram illustrating additional steps of the data management method of FIG. 2.

FIG. 12 is a flow diagram illustrating additional steps of the data management method of FIG. 2.

FIG. 13 is a flow diagram illustrating additional steps of the data management method of FIG. 2.

FIG. 14 is a signal diagram illustrating data exchange in the data management method according to an embodiment of the present invention.

FIG. 15 is a signal diagram illustrating data exchange in the data management method according to another embodiment of the present invention.

FIG. 16 is a schematic overview of an embodiment of a healthcare system according to the present invention.

FIG. 17 is a schematic overview of another embodiment of a healthcare system according to the present invention.

FIG. 18 is a schematic block diagram of an embodiment of a patient information healthcare system according to the present invention.

FIG. 19 is a schematic block diagram of another embodiment of a patient information healthcare system according to the present invention.

FIG. 20 is a schematic block diagram of a further embodiment of a patient information healthcare system according to the present invention.

FIG. 21 is a schematic block diagram of yet another embodiment of a patient information healthcare system according to the present invention.

FIG. 22 is a schematic block diagram of an embodiment of an implantable medical device according to the present invention.

FIG. 23 is a schematic block diagram of an embodiment of a non-implanted communications unit according to the present invention.

### DESCRIPTION OF THE PREFERRED EMBODIMENTS

Throughout the drawings, the same reference characters will be used for corresponding or similar elements.

The present invention is related to management of medical data generated, in a healthcare system, for a patient having an implantable medical device (IMD). In this data management, the present invention takes a totally different approach than the prior art solution of having a domain-specific data manager and registry per affinity domain for managing data documentation on behalf of all IMD patients of that domain. Instead, the present invention teaches a patient-centered data management where each patient has his/her own dedicated data manager and registry which manages data generated in different affinity domains. This means that all information required for successful documentation integration and access, including inter-domain exchange of medical data, is housed, for a given patient, within a so-called patient information hub (PIH) or patient information hub system of the present invention. Thus, the PIH becomes the document depository for the patient in the healthcare system. As an example, in a healthcare system consisting of five affinity domains and in total 100 IMD patients, the prior art solution would be to have five domain-specific data managers/registries, each managing document for up to 100 IMD patients, whereas in the patient-centered technique of the invention, generally 100 patient information hubs are present, each such patient information hub being patient specific but domain transparent.

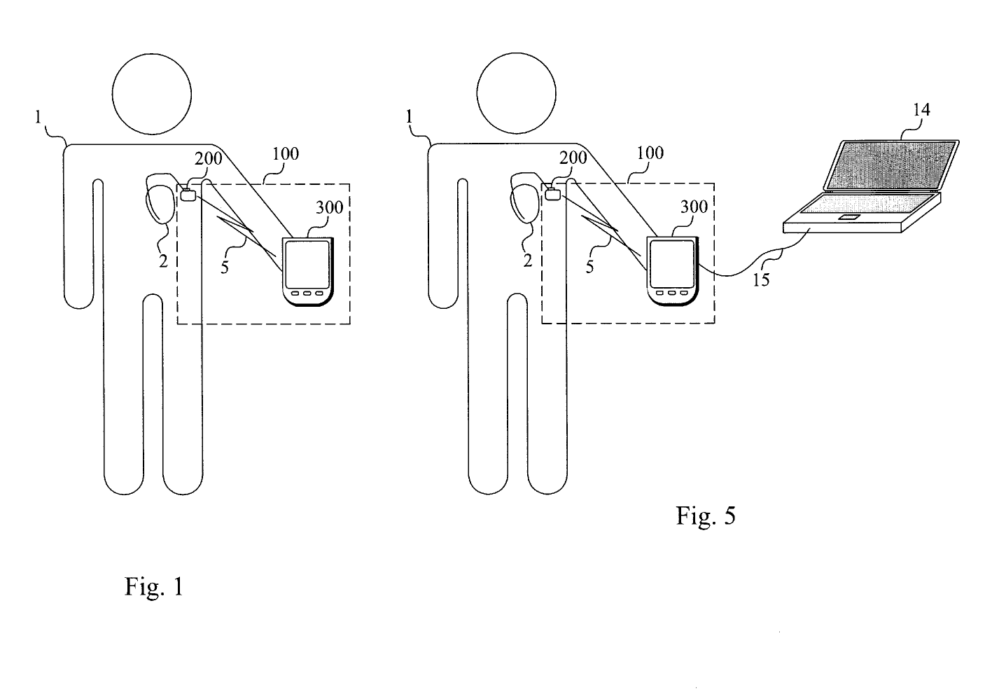

FIG. 1 is a schematic overview of a patient information hub (PIH) system 100 according to an embodiment of the present invention. The PIH system 100 of the present invention in general includes two main units, an implantable medical device 200 and a non-implanted communications unit 300 adapted for conducting communication 5 with the IMD 200. In FIG. 1, the IMD 200 is illustrated as a device that monitors and/or provides therapy to the heart 2 of the patient 1, such as a pacemaker, defibrillator or cardioverter. However, the present invention is not limited to cardiac-associated IMDs but may also be practiced with other implantable medical devices, such as drug pumps, neurological stimulators, physical signal recorders, oxygen sensors, or the like. The non-implanted communications unit 300 is a data processing unit, preferably a portable and handheld unit assigned to and used by the patient 1 and typically also the patient's clinician(s). The data processing unit 300 i) includes, ii) is connected to or iii) wirelessly connectable to transceiver or telemetry equipment for conducting communication, typically wireless communication with the IMD 200. Thus, in this context, the non-implanted unit 300 can be a single device having both IMD-communicating and data processing functionality, be a data processing unit to/in which an IMD-communicating module can be connected/implemented or constitute two separate devices, i.e. one IMD-communicating device/module and one data processing unit, which in turn can communicate with each by through a wire or wirelessly.

The non-implanted communications unit 100 can be realized as a mobile telephone, a Personal Digital Assistance (PDA), a portable laptop/workstation or actually any data processing unit having the capability of communicating with an IMD 200 and preferably with a remote or external workstation, data server or communications device/node.

The PIH system 100 according to the present invention has a memory for storing a list or register that includes information of the data depositories at which medical data documents associated with the patient 1 and/or the IMD 200 are stored. Furthermore, the retrieval of this list from the memory for the purpose of identifying a data document of the patient 1 is performed based on a communication operation involving both the IMD 200 and the non-implanted communications unit 300. This solution provides several advantages over the prior art. Firstly, information of where medical documents constituting the complete medical history of the patient can be found is available from a single location, the PIH 100. A clinician therefore does not have to rely on what the patient recalls when wanting to retrieve a medical document of the patient stored in another external affinity domain. Therefore, when the patient 1 visits a clinician he/she brings the PIH 100, which enables the clinician to access the full medical history of the patient 1. The present invention is also more in line with the emerging trends of medical data management, in which it is the patient 1 should have access to and control access to his/her medical data and that clinicians need the approval of the patient 1 when accessing the medical data. In addition, since the retrieval of the list from the memory is made conditional on a communication operation involving both the IMD 200 and the non-implanted unit 300, unauthorized access to the list by a malicious person stealing or otherwise getting hold of the non-implanted unit 300 is minimized since both the IMD 200 and the non-implanted communications unit 300 are required for obtaining the list.

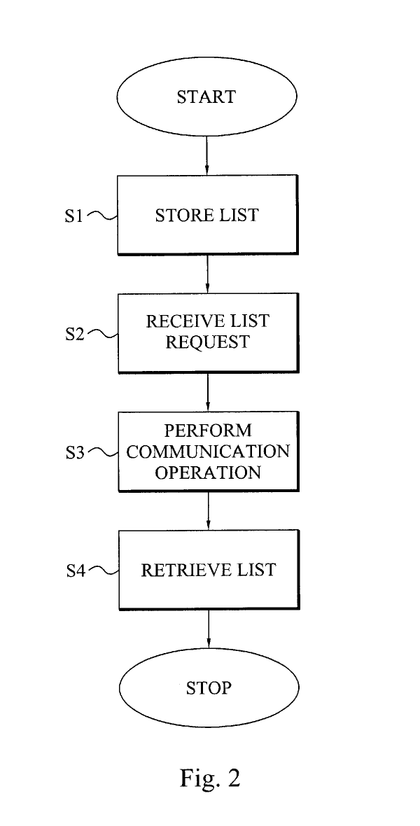

FIG. 2 is a flow diagram of a data management method according to an embodiment of the present invention. The data management method is intended for use in a healthcare system comprising multiple data depositories or repositories storing medical data and other documents associated with and generated for a patient having an implantable medical device. The depositories can be arranged in one and the same affinity domain in the healthcare system but some of the depositories are most typically provided in different such domains.

The IMD has been assigned and has access to a patient information hub which is used as a patient-centered centralized unit when requesting and accessing documents from one of the data depositories. The method starts in step S1, which involves storing a list, register or directory comprising document entries for the medical documents of the patient. This storing step S1 includes storing the list in the PIH system of the patient, which PIH system includes the IMD implanted in the patient and a non-implanted communications unit, such as a PDA, mobile telephone, portable/tablet computer or any other wireless handhold device that can communicate with the IMD. In the following, this non-implanted communications unit will be exemplified by and denoted as a PDA, but this should merely be seen as an illustrative but non-limiting example of a device that can be used as non-implanted communications unit according to the present invention. Each entry includes identification information of a name, title or other identification of the particular document and optionally more extensive metadata in addition to location information useful for identifying the data depository from which the document can be retrieved. This list therefore constitutes a tool when identifying the different documents of the total medical history of the patient and where each document is stored and can be fetched from.

In a next step S2, the PIH system receives a request for the list. This request reception can be in the form of receiving a request message transmitted from an external clinician workstation or any other unit that can communicate with the PDA of the PIH system. In an alternative implementation, the request is provided by activating a user input, such as a button or an activation area of a touch sensitive screen, of the PDA. In either case, the PIH system processes the request and initiates a communication operation involving the PDA and IMD for the purpose of retrieving the list in step S3. This communication operation involves transmitting data from the IMD to the PDA and preferably also transmitting data from the PDA to the IMD. If a correct communication operation has been performed in step S3, the PIH system retrieves the list from the memory based on the communication operation. This dual IMD-PDA communication prevents unauthorized access to the list in readable form from the memory if the PDA should be stolen or end up in the hands of a non-intended person. The method then ends.

The list, thus, includes document information and location information for the medical documents of the patient. The location information can be any contact information or other identification data that allows a user to identify the depository from which the document can be retrieved. In a preferred embodiment, the medical documents, or at least a portion thereof, are stored in electronic form at the multiple data depositories. The location data can then be a Universal Resource Identifier (URI) from which the document can be fetched. For example, the location data can be the address of a Web page of a depository. Alternatively and especially if a document is not provided in electronic form, the location information preferably includes contact information which a user/clinician can use for contacting the personnel at the remote depository and ask them to send a copy of the document to the current user/clinician. In this context, the contact information can include any one or multiple of depository name, post address, visiting address, telephone number, fax number, e-mail address, Web address and name of clinician responsible for generating the medical document.

In a preferred implementation, the list also includes metadata of the data documents, which metadata contains descriptive information of the documents and can be used for facilitating identification of a correct document from the list and/or putting the document in correct medical context. Typical examples of such metadata entries include: submission date of the document at the depository; generation date of the document; medical category of the document; person responsible for the document generation, status of the document (such as preliminary, verified and final); relation to other documents in the depository or other depositories (such as addendum and replacement), Multipurpose Internet Mail Extension (MIME) type of the document (specifies the content type of the document, such as application, audio, example, image, message, model, multipart, text and video, these may in turn include sub-types, e.g. application/pdf, application/xml, text/html, text/plain, image/jpeg, etc.). Table 1 below is a typical example of a portion of such a list that can be used according to the present invention.

TABLE 1
Document list

| Document | | Submission | | |
|---|---|---|---|---|
| name | Depository ID | date | Medical category | MIME type |
| ECG* report | www.clinic1.com | 01 Jun. 2004 | Cardiology report | Image/jpeg |
| Visit note | Clinic 1 | 01 Jun. 2004 | Note of patient visit | Text/plain |
| | P.O. Box 1 | | to PCP** | |
| | SE-100 10 Stockholm | | | |
| Lab report | www.clinic2.com/lab | 15 Aug. 2004 | Laboratory report | Multipart |
| ER*** report | +46 8-123 456 | 20 Sep. 2004 | ER cardiac report | Text/html |

*ECG—electrocardiogram
**PCP—Primary Care Provider
***ER—Emergency Room

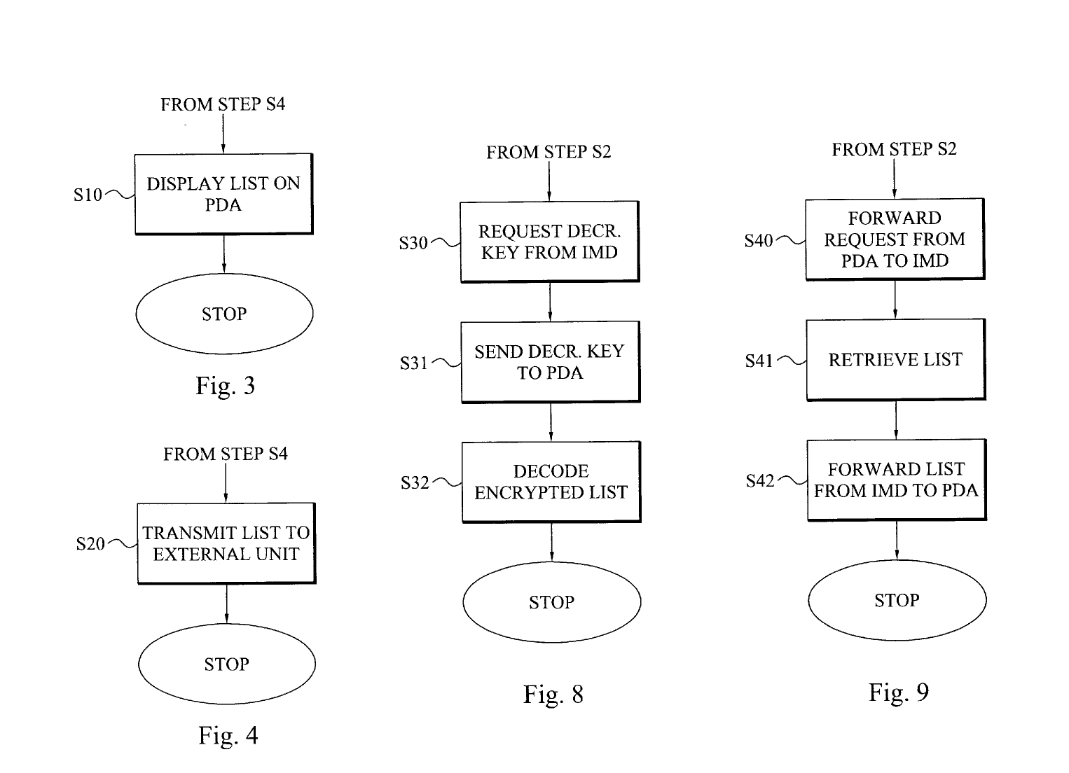

FIG. 3 is a flow diagram of an additional step of the data management method of the present invention. The method continues from step S4 of FIG. 2. In a next step S10, the retrieved list is displayed on a display screen of the PDA. A user can then scroll through the list in order to identify a required document. The preferred metadata included in the list facilitates identification of a desired document by a user of the PIH system. The PDA can include functionality for simply displaying the whole list, such as illustrated by Table 1 above. A user should then review the different entries in the list until he/she identifies the desired document or documents. In this context, the metadata can be of great help, which facilitates the identification of the correct document and reduces the time needed for reviewing/scrolling the list.

The display of the information of the retrieved list can be realized according to different embodiments depending on the preference of the application and the user. For example, in a first embodiment only the document names of the documents found in the retrieved list are shown. In such a case, a user can preferably select one of the document name entries, e.g. by clicking on the touch-sensitive PDA screen, activating a user input, such as a button on the PDA, to display more information of the document, i.e. depository ID and preferably any metadata associated with the medical data document. A second possible implementation could be the display of the document name and depository but not any other metadata. This metadata is then accessible by selecting a given list entry. In a preferred implementation, the PDA can include functionality for switching between different display options so that a user can select an option that suits him/her best.

In a more enhanced embodiment, the PDA includes a search algorithm or program in which a user can enter some catchwords or “search words”. The search algorithm uses these entered words as input and investigates whether any of the entries in the document and location list fulfills the search string or includes the search words. The search criteria can be entered by a user of the PDA or can be received together with the list request from an external unit. Once one or multiple entries fulfilling the search string is found, these entries are displayed on the PDA screen. This embodiment means that only documents of relevance, as determined based on the input search string, become displayed. It will therefore be much easier for a user to quickly identify a desired document as compared to scrolling through the whole list.

In this context, any information contained in the entries could be useful as search input, for example, document name (input word should be found in document name); depository ID (input word should be included in the address or identifier of the depository, for example all documents of a patient found in healthcare facilities in an input city), submission date of the document at the depository and generation date of the document (documents generated/deposited within a specified input time interval and/or generated/deposited before or after an input date); medical category of the document (all documents of a given input category will be displayed); person responsible for the document generation (input word can include name, personnel ID, etc. of physicians), status of the document (input word can be preliminary, verified and final); relation to other documents in the depository or other depositories (input word can be addendum and replacement), MIME type of the document (all document of the input type are displayed). In this context it is of course possible to input search strings in different search categories to more correctly pinpoint a desired document and sift out irrelevant documents. For example, a search string could specify an earliest depository date for a document and a MIME type of the document.

If the depository ID of a desired document is an URI of a Web page from which the document, in electronic form, can be fetched, the PDA can advantageously include a Web browser and functionality for connecting to the Internet. A user could then simply click or select the displayed URI on the PDA window. This causes the Web browser to connect to Internet and the Web server to which the URI points. The document could then be downloaded automatically or by selecting a downloading option. Alternatively, the user first has to perform a login procedure, using security credentials, before accessing and possibly downloading the document, which all will be described in more detail herein. In either case, the document can then be displayed on the PDA, through the Web browser or in downloaded form, for review by the user of the PIH system.

FIG. 4 is a flow diagram of another additional step of the data management method of FIG. 2. The method continues from step S4 of FIG. 2. In the next step S20, the PDA transmits the retrieved list or at least a portion thereof (such as the information of the entries fulfilling the provided search string) to an external unit, which can communicate with the PDA. This external unit can be a workstation of a physician, who the patient visits. In such a case, the PDA can be plugged to the workstation or transmit the list wirelessly. Alternatively, the list is sent, through a network, such as a radio-based, possibly cellular, network, to a remote physician's workstation. The list is then displayed and optionally processed (searched through by a search algorithm) at the workstation in similar manner to what has been described in the foregoing.

FIG. 5 is a schematic overview of a PIH system 100 according to the present invention adapted for communication with an external workstation 14. In a typical scenario, to which the teachings of the present invention can be applied, the patient 1 visits a physician. The patient 1 has an implanted medical device 200 and brings his assigned PDA 300, which together forms the PIH system 100. At this visit the physician would like to check on any previous treatments and/or diagnostics of the patient 1 performed in other healthcare enterprises. In a first implementation, the patient 1 lends the physician his/her PDA 300, thereby authorizes the physician to access his/her list of medical document history. The physician switches on, if not already on, the PDA 300. A possible password or PIN (Personal Identification Number) code might have to be entered for activating the PDA 300 and prevent unauthorized usage of the PDA 300. In such a case, the patient 1 preferably enters the PIN code before handing the PDA 300 to the physician.

The physician then activates a user input of the PDA 300, such as pressing on one of the buttons on the PDA 300 and/or activating an area of a touch-sensitive screen of the PDA 300 for generating a request of the list stored in the PIH system 100. In this context, it could be possible that the physician must scroll through different windows or menus before being able to generate the request signal. The PDA 300 processes this request signal and performs a communication operation 5 with the IMD 200 for the purpose of being able to access the document list of the PIH system 100. The retrieved list is then displayed on the PDA 300 and the physician can investigate if any document of interest is available in the complete medical record of the patient 1.

In another embodiment, as illustrated in FIG. 5, the physician connects the PDA 300 of the PIH 100 to the network of the physician via his/her workstation 14, by using a wired connection 15. In this context any port useful for connecting communicating devices is possible, including USB (Universal Serial Bus) ports and dedicated PDA ports. The physician then uses his/her workstation 14 for compiling and forwarding to the PDA a query to access the list of documents of this patient 1. In this communication, exchange of security attributes, such as Certificate Authority (CA) issued certificates and tokens, preferably takes place to authenticate the two communicating units 14, 300.

The PDA 300 processes the query and performs together with the IMD 200 a communication operation 5 by exchanging information. This in turn allows retrieval of the list which becomes displayed on the PDA 300 or is forwarded and displayed in transient form on the workstation 14. In the latter case, the list is transiently and temporarily stored in the workstation 14 and should be removed therefrom once the patient session is ended. This means that the list is preferably not available on the workstation 14 once the patient 1 leaves the physician. Exceptions can be made if granted by the patient 1.

In addition, during the visit the physician might generate new medical data documents associated with at least one of the patient 1 and the IMD 200. Such a document could contain diagnostic data, a diagnosis made by the physician, the physician's comments in connection to the visit, a prescription of a drug issued to the patient 1, treatment details, a visit note for a scheduled next patient visit, data concerning the operation and/or settings of the IMD 200, or actually any data and documentation that is generated during the normal activity of a physician and should be included in the patient's health record. This generated document is stored in a data depository available for the physician and the current healthcare facility. The registration of the new document(s) in the depository is also, typically at the end of the visit, notified to the PDA 300 through the workstation 14. The PDA 300 processes this notification and updates the document list stored in the PIH system 100 based on the new information.

In a possible implementation, the PDA 300 can operate for automatically or at least semi-automatically updating the stored document list based on the update information received from the workstation 14. Alternatively, the physician 300 uses the PDA 300 when requesting for any update information from the workstation 14 and then for selecting a list update option. In such a case, instructions for performing such an update procedure can be displayed on the screen of the PDA 300 thereby facilitating this procedure for new physicians not familiar with handling the PIH system 100.

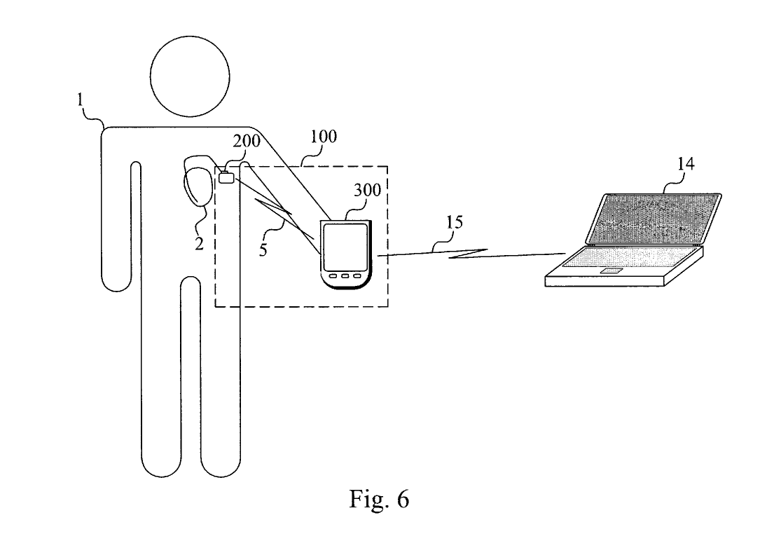

FIG. 6 is another schematic overview of a PIH system 100 of the invention and its communication with an external workstation 14. Compared to the case illustrated in FIG. 5, the PDA 300 of the PIH system 100 communicates wirelessly 15 with the physician's workstation. This communication 15 can be in the form of radio-based communication, such RF (Radio Frequency) communication or BLUETOOTH®, IR (Infra Red) communication or any other suitable short-range (or long-range) wireless communication. The operation of the PIH system 100 and the workstation 14 is otherwise similar to what has been described above in connection to FIG. 5.

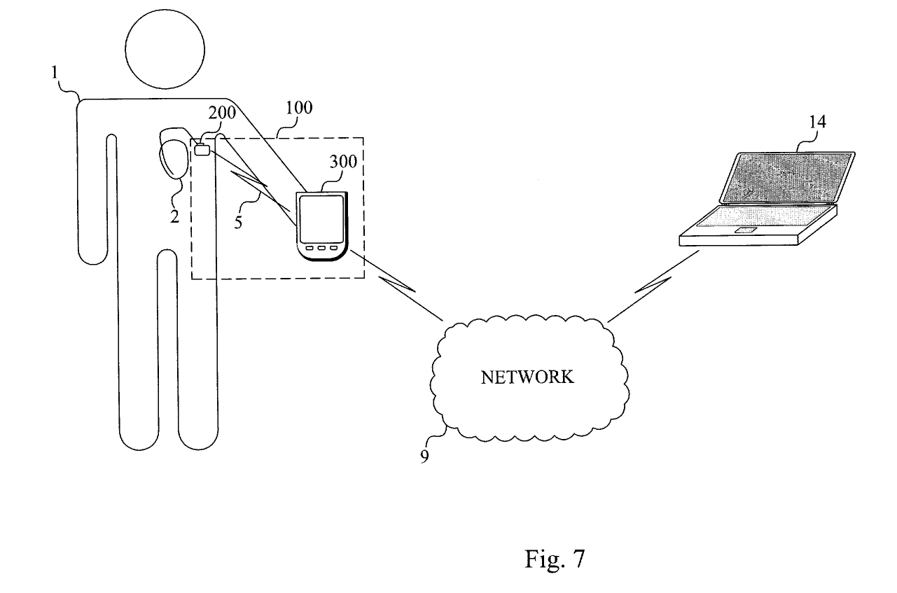

In FIG. 7, the PIH system 100 communicates with a remote workstation 14 or other data processing unit over a network 9. This network 9 can for example, be a wide area mobile network, local area network or some other network useful for communicating data between a source node and a destination node. This embodiment allows a physician to request, using the workstation 14, the document list of a patient 1 even in cases where the patient 1 is not visiting the physician, i.e. remote request.

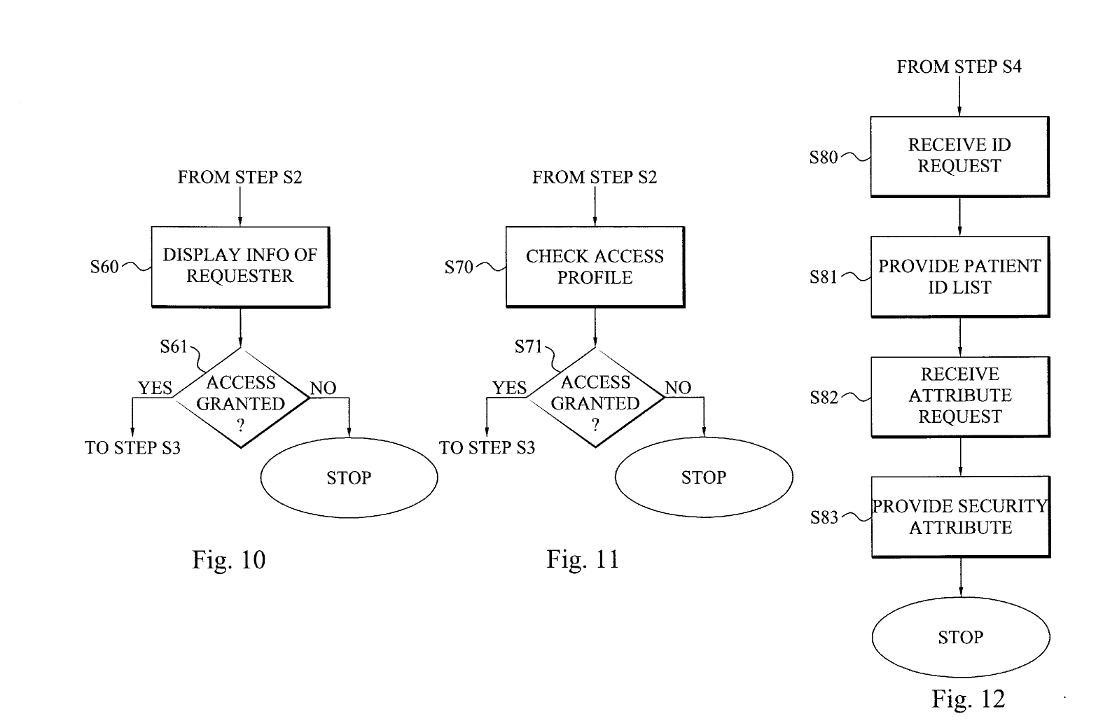

With reference to FIG. 7 and FIG. 10, the physician's workstation 14 compiles and sends a list request over the network 9 to the PDA 300. This request preferably also comprises an identifier of the physician. The request is received by the PDA 300 in step S2 of FIG. 2. In a next step S60, the request is displayed on the PDA screen for the user 1. In a preferred embodiment, the user 1 has a choice between granting and denying the list request, by activating a user input of the PDA 300 in step S61. In the former case, the PDA 300 and IMD 200 become involved in a communication operation 5 and the list is retrieved from its storage location(s) in the PIH system 100 as is disclosed by step S3 of FIG. 2. The PDA 300 communicates the list, preferably in an encrypted form, to the requesting workstation 14 over the network 9. In the denying case, the list is not retrieved nor transmitted to the workstation 14. The PDA 300 could possible return a denial report to the workstation 14 informing the physician of the user's denial of his/her request.

By including the physician identifier in the request, the patient 1 will be informed of who the list requester is. In an alternative implementation, the PDA 300 and the workstation 14 are involved in a mutual authentication procedure before processing the list request. The PDA 300 could then use information exchanged in this authentication procedure for informing the patient 1 who the request originated from. In either case, the patient 1 will then be able to determine if the requesting person should be given access to the patient's document list or not depending on whether the patient 1 recognizes the requester and feels that he/she can trust the requester with the list.

In an alternative or additional embodiment, which is particularly suitable for less technology-versed patients 1, the PIH system 100 has access to an access profile defining data access rights to the list and/or medical documents found in the list for different users in the healthcare system. This means that different physicians and other actors in the healthcare system have, for the given patient 1, been assigned different levels of clearance to the medical documentation of the patient 1. In first embodiment, similar to the on-off principle, users notified on the access profile are given full access to the documentation list, whereas other users not mentioned in the profile is denied list access. This principle is schematically illustrated in FIG. 11. The method continues from step S2 of FIG. 2. In a next step S70, the PIH system 100 uses information included in the request or transmitted separately (user ID) or authentication information for checking the access level of that user in the profile. This can be realized by a simple search through the access profile entries with the provided user ID/authentication information as search string. If the user is granted access in step S71, the list is retrieved from the PIH system 100 and is forwarded to the workstation 14, see step S3 of FIG. 2. Otherwise an optional access denial message can be compiled and returned.

It could also be possible to have different levels of access specified in the access profile. For example, the patient's primary physician could be given full access to the list and all documents included therein, whereas the IMD provider will only be able to access those parts of the list that relates to medical documents containing information of the operations and settings of the IMD 200 but no other patient-pertaining documentation. In such a case, each entry of the documentation list preferably comprises a notification of access level to be applied to that particular medical document. The PIH system 100 then uses information of the requesting user received in a message (list request) or during the authentication procedure and investigates the access profile to find the access level assigned to this particular user. The portion of the documentation list that includes document entries corresponding to the access level of the requester is retrieved in the PIH system 100 through a communication operation 5 of the IMD 200 and the PDA 300. The retrieved granted portion of the list document is then returned, preferably in an encrypted form to the workstation 14.

The restricted access solution described above, i.e. granted by the patient having the PIH or through an access profile, can of course be applied to other data stored and managed by the PIH system, such as security attributes and patient identifier lists (described further herein).

FIG. 8 is a flow diagram illustrating an embodiment of the performing and retrieving steps of FIG. 2 in more detail. In this embodiment, the memory storing the document list is at least partly found in the PDA of the PIH system. In addition, the document list stored in the PDA is preferably in an encrypted or coded form to prevent access therefore in readable form if the PDA should be stolen or used by a non-authorized person. The method continues from step S2 of FIG. 2, in which the PDA of the PIH system received (from an external unit or through activation of a user input) a list request. The PDA in turn processes this request for the purpose of generating a request for a decryption or decoding key stored in the IMD. The key request is sent to the IMD in step S30, which processes and provides the requested key from a key storage. Alternatively, the decryption key is generated on the fly upon reception of the key request. The IMD returns, in step S31, the provided key to the PDA for usage therein. The PDA decrypts the encrypted form of the document list using the received decryption key in step S32. This decoded and readable form of the list can be displayed on the PDA for a user or physician or be transmitted further to physician's workstation.

In a preferred embodiment, the decrypted document list is in a readable transient form. This implies that the list in this non-encrypted form is preferably only transiently and temporarily available in the PDA, such as in a memory or cache of the PDA. After the current data management session has ended, the list in readable transient form is removed from the PDA (memory/cache) so that it will only be found in the PDA as an encrypted list representation or version. In a corresponding manner, the decryption key received from the IMD should be deleted from the PDA after its use and at least after the end of the session. This prevents a malicious person from accessing the list in readable form by stealing or otherwise getting hold of the PDA.

If the non-implanted communicating unit is a mobile radio-communication unit, such as a mobile telephone, cellular telephone or PDA, which comprises a tamper-resistant identity module, typically denoted Subscriber Identity Module (SIM) in the art, the encoded document list can be stored on the SIM. In this context the SIM can be a standard SIM card used in GSM (Global System for Mobile Communications) mobile telephones but can be any network subscriber identity module known to the art, including also UMTS (Universal Mobile Telecommunications System) SIM, WAP (Wireless Application Protocol) SIM and ISIM (Internet Multimedia Services Identity Module) modules. By storing the document list in an SIM, the list is potentially more secure than in a hostile PC or PDA environment. This is because the operating system platforms of PCs, e.g. Windows and Linux, and PDAs are more well known by the public than corresponding platforms of SIM modules, which thereby become harder to attack and modify. The fact that the SIM normally is removably arranged in relation to the mobile phone or PDA makes it easy to move the SIM with its stored document list between different non-implanted communications devices of the patient.

In addition, since access to the SIM card can be restricted and protected by a PIN code or other password, it could be possible to store the document list in a non-encrypted and readable form. In such a case, the required PIN code could be stored in the IMD and temporarily sent to the PDA for accessing the list stored on the SIM.

FIG. 9 is a flow diagram of another embodiment of the performing and retrieving steps of FIG. 2. In this embodiment, the memory of the PIH system storing the document list of the patient is at least partly implemented in the IMD implanted in the patient. The method continues from step S2 of FIG. 2. In a next step S40, the PDA forwards the received list request or generates a list request for transmission to the IMD. The IMD retrieves, in response to reception of the request, the list from its memory in step S41 and forwards it to the PDA in step S42 for display or further forwarding to an external unit.

In this context, the retrieval and transmission of the document list from the IMD to the PDA could be conditional on that the IMD is actually implanted in the patient. In such a case, the IMD comprises a memory manager adapted for retrieving the document list from an IMD memory if and only if a sensor arranged in the IMD or connected thereto senses that the IMD is actually implanted in the patient. In such a case, the sensor generates an access signal representative of a correct implantation and forwards it to the memory manager. The list retrieving operation of the manager will be performed based on this access signal. Similarly, if the sensor does not sense a correct implementation, it could generate a restriction or lock signal. In the former case, the manager simply does not access the memory. In the latter case, the manager becomes, at least temporarily, locked and cannot retrieve the list even if a subsequent access signal is generated by the sensor. This is in particular suitable if someone tries to take an explanted IMD and provide an artificially generated access signal. The sensor can then sense, if the sensing is performed at multiple scheduled instances, that the IMD has been explanted before the generation of the fraudulent access signal.

The sensor arrangement is preferably arranged for performing the decision and signal generation based on (physical) parameter data measured and collected from the patient body. The sensor compares the measured data with a defined default value or default range that is representative of a correct implantation. Thus, if the measured value corresponds to the default value or falls within the default range, the sensor arrangement considers the device to be implanted in the patient body. Examples of such parameter values include, temperature, lead impedance of a heart probe, intra cardiac signals, oxygen levels, respiratory signals, light measurement data, etc. It is anticipated that the sensor arrangement can measure and sense multiple different parameter values.

This usage of sensor can of course also be applied when providing other data, including the decryption key, patient identifier list and security attributes, from the IMD for transmission to the PDA.

The two embodiments described above and disclosed in FIGS. 8 and 9 can be combined so that a part of the document list is stored in a memory of the IMD and a remaining part of the list is stored in another memory of the PDA, preferably in an encrypted form. It is also possible to store the complete list in the IMD and (in encrypted form) in the PDA, where the IMD list copy functions as a back-up if the PDA would become lost.

In a preferred embodiment of the present invention, the data (document list, decryption key and optionally requests thereof) communicated between the PDA and the IMD is preferably encoded to prevent a malicious person from using any overheard information. In this context any known techniques and solutions used for data protection known in the art can be applied to the present invention. For example, symmetric keys or private-public key pairs are possible examples. Correspondingly, the PDA and IMD preferably mutually authenticate each other, or at least the PDA is authenticated by the IMD. A typical example of a useful authentication procedure could be usage of available CA issued tokens found in the IMD and PDA. Alternatively, the PDA and IMD can each have access to an instance or copy of a hash function (one-way function). During the authentication procedure, the PDA (or IMD) generates a random number or string, which is used as input to the hash function. The output and the generated random number are transmitted to the IMD (or PDA). The IMD (or PDA) uses its version of the hash function and the received random number to calculate its own output. If this calculated output is equal to the received one, the IMD (or PDA) considers the PDA (or IMD) to be correctly authenticated.

It is anticipated by the present invention that the PIH system can handle other information useful for medical data management and distribution in a healthcare system besides the document list. For example, each affinity domain can in turn be divided into different so-called patient-identifier domains or constitute one single such patient-identifier domain. A patient-identifier domain is characterized by having a uniquely assigned identifier of a patient used by healthcare facilities of that domain. Thus, all healthcare facilities and providers within a patient-identifier domain use a same patient identifier for a given patient. However, the given patient is often assigned other patient identifiers used by healthcare facilities belonging to other patient-identifier domains. This of course constitutes yet another obstacle in the integration of medical documents in a healthcare system.

According to an embodiment of the present invention, the PIH system will handle the different patient identifiers assigned to the IMD patient and used by the different patient-identifier domains, which the patient has visited. The IHE TF documents [1, 2] has suggested a solution where each affinity domain has a PIX manager that stores all patient identifiers assigned to all patients within the domain and used by the different patient-identifier domains within the affinity domain. The present invention takes a radically different approach by allowing each patient, through its PIH system, to be its own PIX manager. This means that instead of having one PIX manager per affinity domain, the present invention teaches the usage of one PIX manager per IMD patient for all affinity domains.

The PIH system therefore preferably has a memory for storing a list, database or register containing, per entry, an identifier assigned to the patient and an identifier of the patient-domain which uses this identifier. This domain identifier could simply be a listing of those healthcare facilities that belong to the domain, the regional identifier of the domain (city, state, country) or some other useful domain identifier. Alternatively, patient identifiers constitute metadata of the document list so that each entry in the document list contains information of the patient identifier used in the domain in which the depository comprising the document of that particular entry is housed. This patient identifier data are then very useful for a physician who is about to retrieve a medical document of the patient found in a depository of another patient-identifier domain. Firstly, the document list stored in the PIH system allows the physician to identify where the document can be found. Secondly, the location information from the document list is used together with the patient identifier list stored in the PIH system for finding out which patient identifier the physician should use when contacting the document depository.

Other useful information that can be stored in and handled by the PIH system of the present invention includes different security attributes used when authenticating different devices in the healthcare system, for decrypting/encrypting transmitted data and/or for accessing depositories, healthcare services, etc. For example, a physician has accessed the document list from the PIH system of the invention as previously described and been notified a vendor's portal from which a medical document can be accessed. However, for accessing this portal, the physician might be requested to type in a user name and a password and optionally for extended security a one-time temporary key (code) that is valid only during one session. It would be very difficult, if not next to impossible, for a physician to memorize and maintain all possible passwords, user names and key generation devices/cards that he/she needs in everyday work when treating very different patients and interfacing with several depositories and portals.

The present invention solves these problems since the patient carries the device, i.e. patient information hub, which contains user name and passwords for being able to access the patient's medical data from a depository or portal where it is stored. The PIH can also include capabilities for generating temporary and one-time keys and codes. In this context, the patient could be assigned one and a same user name and password for all available depositories. In such a case, these security credentials can be stored in key store or other memory of the PIH system, preferably in the IMD of the PIH system. If, however, different data depositories use different security credentials for the same patient, these different credentials can be collectively found in a list together with an identifier of the depositories which use them or the credentials could constitute part of the metadata preferably found in the document list. In either case, the physician can simply read the list or use a search algorithm for finding the correct credentials from the list. If the credential list is stored in the PDA, it is preferably stored in an encrypted form.

FIG. 12 is a flow diagram illustrating additional steps of the data management method of FIG. 2. The method continues from step S4 of FIG. 2. In a next step S80, the PDA of the PIH system receives a request for a patient identifier assigned to the patient within a patient-identifier domain. This request can originate from an external unit communicating with the PDA or be generated by activating a user input of the PDA. In a next step S81, the PIH system provides the list so that is displayed on the PDA or is transmitted to an external unit. This can be realized by simply fetching the document list as previously described if the patient identifiers are included as metadata therein. If instead found in a separate list, this list is then fetched from its storage location in step S81, preferably based on communication operation involving the IMD and the PDA (see FIG. 8 or 9). The ID request received in step S80 could include the identifier of the depository or domain, which uses the requested patient identifier. In such a case, the PIH system can process its identifier or document list for identifying the requested patient identifier. Therefore, only this requested patient identifier need to be displayed or forwarded.

In a next step S82, the PDA of the PIH system receives (from external unit or via user input activation) a request for security attributes required for, e.g., accessing a document depository or portal and/or node-node authentication. In a next step S83, the PIH system provides the requested security attributes by, for example, returning an attribute list comprising security attributes assigned to the current patient, returning the document list (attributes being included as metadata) or generating the attribute on the fly based on the request. In this context, the attribute providing functionality could be found on the PDA but is preferably arranged in the IMD. In either case, the provision of the attributes is preferably conditioned on a correct communication operation involving the IMD and PDA and/or a correct implantation of the IMD in the patient.

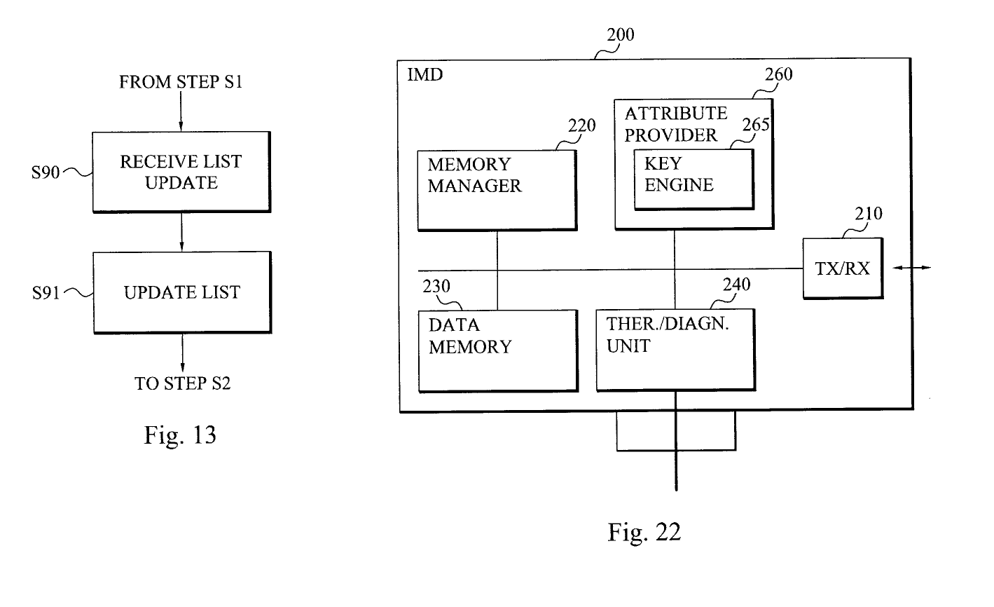

FIG. 13 is additional steps of the data management method of FIG. 2. The method continues from step S1 of FIG. 2. In a next step S90, the PIH system, preferably the PDA part of the PIH system, receives update information from an external unit. This update information could include information of new medical documents generated for the patient or the IMD of the patient and constitutes a part of the medical record of the patient. In such a case, the update information also comprises information of from where the document is available, such as a depository URI, address or identifier. In addition, the update preferably also includes metadata of the new document. This information updating can of course also take place for other data managed by and stored in the PIH system, such as the previously described patient identifiers and security credentials.

The list update could be performed online, implying that when the patient visits a physician, the PDA of the patient's PIH system becomes (wired or wireless) connected to the local (XDS) depository of the healthcare facility through the physician's workstation. Any new medical data generated for the patient, such as during the current visit, and registered at the depository is notified in the list update transmitted to the PDA in step S90.

In an alternative solution an offline approach is taken. This means that updates can be sent wirelessly to the PDA using a network, for example in the form of a SMS (Short Messaging Service) message, MMS (Multimedia Messaging Service) message or e-mail. In such a case, the depositories of the healthcare system can be configured for generating and communicating an update message once new documents pertaining to the patient have been registered at the depositories. In an alternative approach, the depositories are configured for sending any available new update information at scheduled transmission occasions, such as once every day, week or month.

It could also be possible that the PIH system interrogates the different depositories in the healthcare system for any update information for the current patient. This interrogation can be realized through unicasting, multicasting or broadcasting one or more update interrogation messages. In such a case, the interrogation message should include the patient identifier used by the depositories, implying that for a broadcast solution several identifiers might have to be included in the broadcast message, whereas in the unicast or multicast case, the message(s) can be directed to a single depository or those depositories within a patient identifier domain.

In either case, once the update information is received in step S90, the PIH system updates its stored document list based on the received update information in step S91. Depending on where the list is actually stored, the updating can be performed by the IMD and/or the PDA. The PIH system can be configured for performing the list update automatically. In alternative approach, the user/patient is notified of the update information through the PDA and could possible be requested to accept the information before the list update procedure can be initiated. In such a case, the PDA display screen preferably displays instruction of how the user should act for allowing the update information to be entered in the list. The method then continues to step S2 of FIG. 2.

The present invention preferably also use a back-up function, especially if the document list is only stored (in encrypted form) on the PDA. This means that the PDA of the PIH system is configured for securely transmitted (through a secure line or using data encryption) the document list stored in the PIH system to an external secure database managed by a service provider. This service provider could be a company specialized for providing this type of data storage service to healthcare customers. Alternatively, the device manufacturer of the patient's IMD could also have this back-up functionality. Actually, any external party trusted for this task could take the role of list back-up manager according to the present invention. The storage of the back-up copy of the document list may take place automatically according to a defined schedule and using wireless transmission of the list copy from the PDA to the external storage location. Alternatively, the patient himself/herself could access, using a PC or other computer/workstation, a Web page of the service provider. The patient is preferably requested to type in a user name and password for accessing a site through which the back-up list copy can be uploaded from the PDA to the storage database. In such a case, the security credentials required for this log in procedure are preferably stored in the PIH system, such as on the IMD of the system and can be sent therefrom through the PDA and computer to the remote server/database. This means that the PDA should be connected to an Internet-computer, through a cord or wirelessly through BLUETOOTH® or IR. Note also that the PDA may not be connected to a computer at all since it is in the prime case itself an Internet Protocol (IP) device and is able to conduct TCP/IP (Transmission Control Protocol) communication over different physical networks using different protocols, such as Wi-Fi (Wireless Fidelity), wmax, GPRS (General Packet Radio Service), etc. In either case, a back-up copy becomes uploaded from the PIH system to the remote database. It is also of course possible that the patient once in a while actually visits the back-up service provider to enter the back-up copy when being in place.

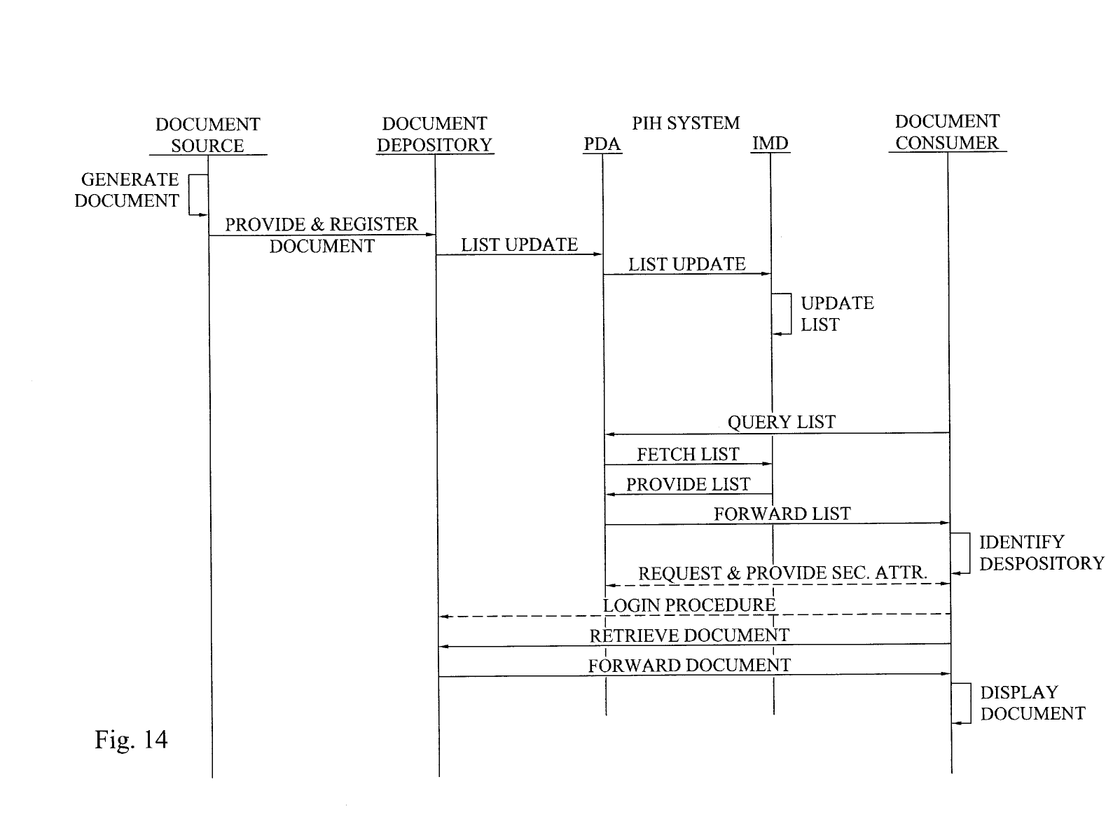

FIG. 14 is a signal diagram illustrating the possible actors that can be involved in the data management and exchange according to the present invention in a healthcare system. The actors include a document source, which is the producer and publisher of medical documents of an IMD patient. It is responsible for sending the documents to its assigned document depository. It also preferably supplies metadata to the document depository for subsequent registration of the documents with the PIH system of the invention.

The document depository is responsible for both the persistent storage of these documents as well as for their registration with the PIH system. It preferably assigns a URI to documents for facilitating subsequent retrieval by a document consumer.

The PIH system according to the present invention takes the role of and replaces the prior art central and domain- but not patient-unique document registry. This means that the PIH system comprises a list and metadata about each registered document in a document entry. This preferably includes a link (URI) to the document in the document depository where it is stored. The PIH system responds to queries from document consumers about documents meeting specific criteria. It may also enforce some healthcare specific technical policies at the time of document registration.

The document consumer queries the PIH system for documents meeting certain criteria or for the document list, and retrieves selected documents from one or more document depositories.

In the transactions of the system, the document source has generated a document associated with a given patient. This typically takes place when a clinician or other medical personnel creates, using his/her workstation, a diagnostic, medical or other type of document, which should be included in the file or record of the patient. The document source (clinician workstation) initiates a provide and register document transaction. This means that the generated document is transmitted to the document depository assigned for the document source, typically one local depository of the healthcare facility or a remote “super-depository” available for multiple facilities. In a typical implementation, in line with the IHE IT Infrastructure TF, the document source preferably provides both the document as an opaque (octet) stream and the corresponding metadata to the document depository. The depository is responsible to persistently store this document and to register it in the PIH system using a update list or register document transaction by forwarding document metadata (location data, document name and further metadata) to the PIH system.

The document depository, thus, initiates the list update/document register transaction. This allows a depository to register one or more documents with the PIH system, by supplying metadata about each document to be registered. This document metadata will be used by the PIH system to create a document entry in the document list stored in the PIH system.

In the PIH system illustrated in FIG. 14, the PDA receives this list update from the depository and forwards it to the IMD, where the document list is actually stored. The IMD enters the received metadata as a new entry in the list, which thereby becomes updated. If the IMD lacks functionality for list updatings, the document list is first sent to the PDA which updates it based on the received metadata. The PDA thereafter returns the updated list to the IMD for storage.

A query list transaction is issued by the document consumer on behalf of a care provider to the PIH system, preferably the PDA part of the PIH system. In a first embodiment, the PDA sends a fetch list request to the IMD, which retrieves the document list from its memory and provides it to the PDA. The PDA forwards the requested list to the document consumer. In another embodiment, the PDA searches the document list to locate documents that meet the consumer's specified query criteria. It will then return a list of document entries that contain metadata found to meet the specified criteria including the locations and identifier of each corresponding document in one or more document depositories. In still another embodiment, the PDA forward the query criteria to the IMD, which performs the list search and returns a list of document entries fulfilling the search criteria, which are returned to the consumer. In these latter embodiments the query list message includes the search string used by the PDA or IMD for identifying relevant documents.

It is actually possible that the PDA of the PIH system, in addition to having a part role as document registry could also be a document consumer. In such a case, a user uses the PDA for inputting a document list request or a list query including a search string. The PIH system processes this request/query and will display the fetched document list on the PDA screen or the list of the documents from the document list fulfilling the search string.

The document consumer (or its user) reviews the provided document list (the whole document list stored in the IMD or those entries that could be relevant) for identifying the document, which should be retrieved, and in which depository it is stored.

In addition to request/query the document list, the document consumer can also request security attributes required for accessing the identified depository storing the required document. In such a case, the PIH system provides or generates the required attributes, unless already included in the previously returned list, and forwards them to the document consumer or alternatively displays them on the PDA.

The document consumer initiates a retrieve document transaction, typically by clicking on a link included in the returned document list and accessing the document depository using a Web browser. The consumer can be required to authenticate itself using authentication tokens received from the PIH system, log in using user name/password from the PIH system and/or enter a session code also received from the PIH system. The document depository will return the document that was specified by the document source in its retrieve document request. The consumer can now process the document, such as display it on a workstation.

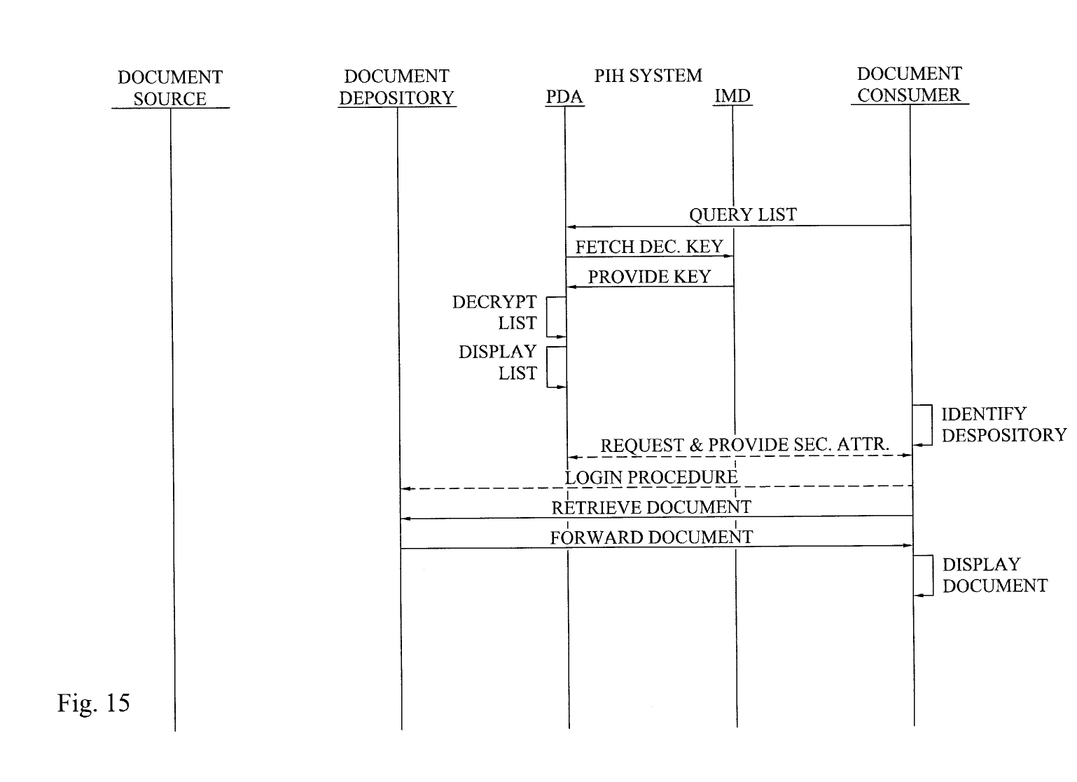

FIG. 15 is a corresponding signal diagram employing another embodiment of a PIH system according to the present invention. In this case, the document list is stored in encrypted form on the PDA. The PDA receives a list query or request similar to FIG. 15. This causes the PDA to request the IMD to provide or generate a decryption key and return it to the PDA. The PDA decrypts the document list to provide it in a transient and readable form. The decrypted list can then be displayed on the PDA or forwarded to the document consumer. Alternatively, only those entries of the list that fulfils a search query provided together with the list query are displayed by the PDA. The following transactions are similar to FIG. 14 and are not repeated herein. Once the PDA-consumer communication has ended, the PDA removes the transient readable form of the list so that it is only available in encrypted form on the PDA.

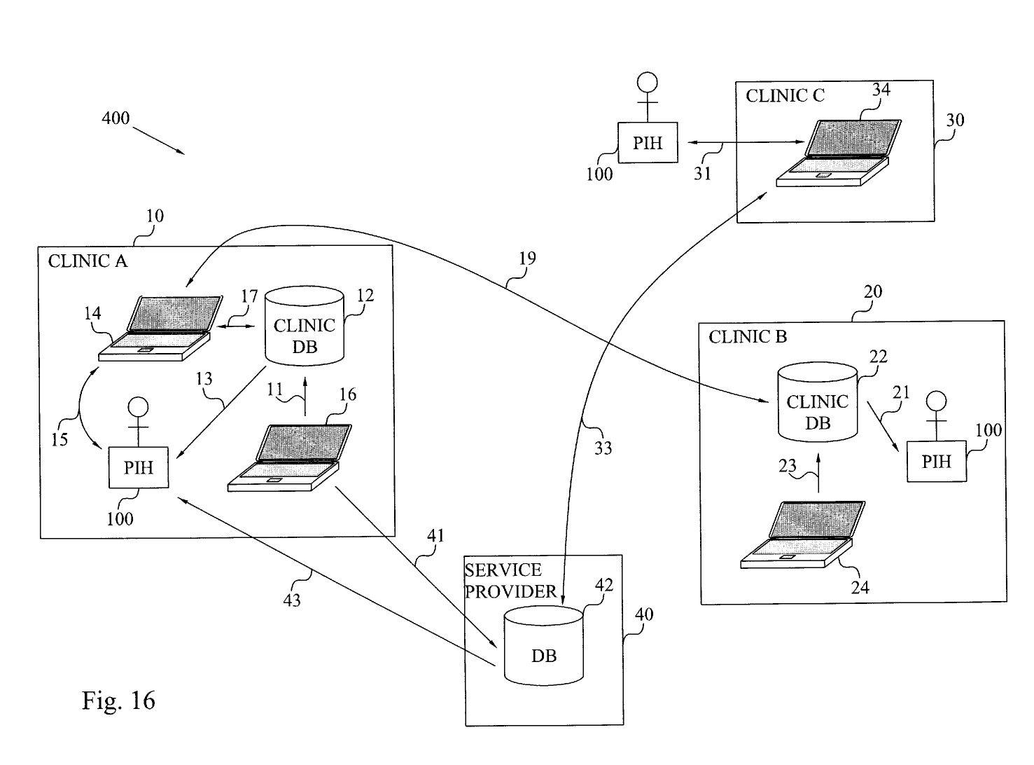

FIG. 16 is a schematic overview of a healthcare system 400 comprising multiple healthcare providers 10, 20, 30, 40 and a patient having a PIH system 100 according to the present invention. FIG. 16 is provided to illustrate how the PIH system 100 of the invention can be used when a patient visits different clinics 10, 20 in the healthcare system and clinicians in different clinics 10, 30 request documents from the patient's medical record.

Firstly the patient visits a physician at a clinic A 10 for performing a medical examination of the patient. The physician uses his/her workstation 16 for communicating with the IMD of the patient. In this example, the IMD could send collected medical data pertaining to the condition of his/her heart and current IMD parameter settings. The physician 16 uses this input data for compiling two medical documents, a first document relating to the diagnostic heart data and a second document containing the parameter settings. The first document is transmitted 11 to the local depository or document database 12 of the clinic A 10 for storage therein. Correspondingly, the second document can be sent 41 to an external service provider 40, such as the IMD manufacturer, for storage in a database/depositories 42. Both these depositories 12, 42 register 13, 43 the first and second document, respectively, in the PIH system 100. The PIH system 100 updates its document list with two new entries corresponding to these to documents. The registration 13 of the first document can be performed online through the physician's workstation 16, whereas the external service provider 40 can use an offline registration 43 by sending a message over a communications network.

At a later instant the patient visits a physician in a clinic B 20. This physician performs, e.g. ultrasound measurements of the patients heart using a suitable measuring equipment 24. The measurement data is processed and a third (diagnostic) document is compiled and uploaded 23 at the local depository 22 of the clinic B 20. The depository 22 registers 21 the new received document to the PIH system 100, which updates its document list.

The patient once more visits a physician of the clinic A 10. The physician would like to obtain some newly collected medical and diagnostic data of the patient's heart condition. The physician uses his workstation 14 for requesting 15 such new diagnostic documents from the PIH system 100. The PIH system 100 performs a communication operation involving the IMD and the PDA and retrieves the document list from its memory. A search algorithm in the PDA preferably identifies those diagnostic documents that has been generated and registered rather recently. In this example, the PDA identifies the first and third document and either displays the information thereof on the PDA or returns it to the workstation 14. In either case, the physician can see that these two documents are of relevance and he/she therefore should retrieve them. The first document is stored in the local depository 12 of the clinic A 10. This means that workstation 14 can send a local intranet document request 17 to the depository 12, which returns the first document. The third document is however stored at a depository 22 of a remote clinic 20. The physician contacts 19 this depository 22, typically by clicking on a link to a Web page managed by the clinic B 20 for this purpose. Security attributes from the PIH system 100 can be used for logging in to the depository 22 and retrieving 19 the ultrasound document therefrom.

As has been discussed in the foregoing, the patient does not necessarily have to visit a physician for the physician to query for a document. For example, a physician in a clinic C 30 can request 31 the PIH system 100 for any document relating to the IMD settings of the patient. The patient could preferably accept or deny this request using his/her PDA or acceptance/denial is made automatically through an access rights profile. The document list of the PIH system 100 is retrieved according the teachings of the present invention and information of any documents (the second document) containing IMD setting data is returned 31 to the workstation 34. The physician identifies the depository 42 for the relevant document(s) and retrieves 33 them therefrom.

In this context, it is of course possible, especially if the non-implanted communications unit of the PIH system is a mobile telephone, for the physician to actually call the patient for discussing the physician's need for one or more documents of the patient's medical record.

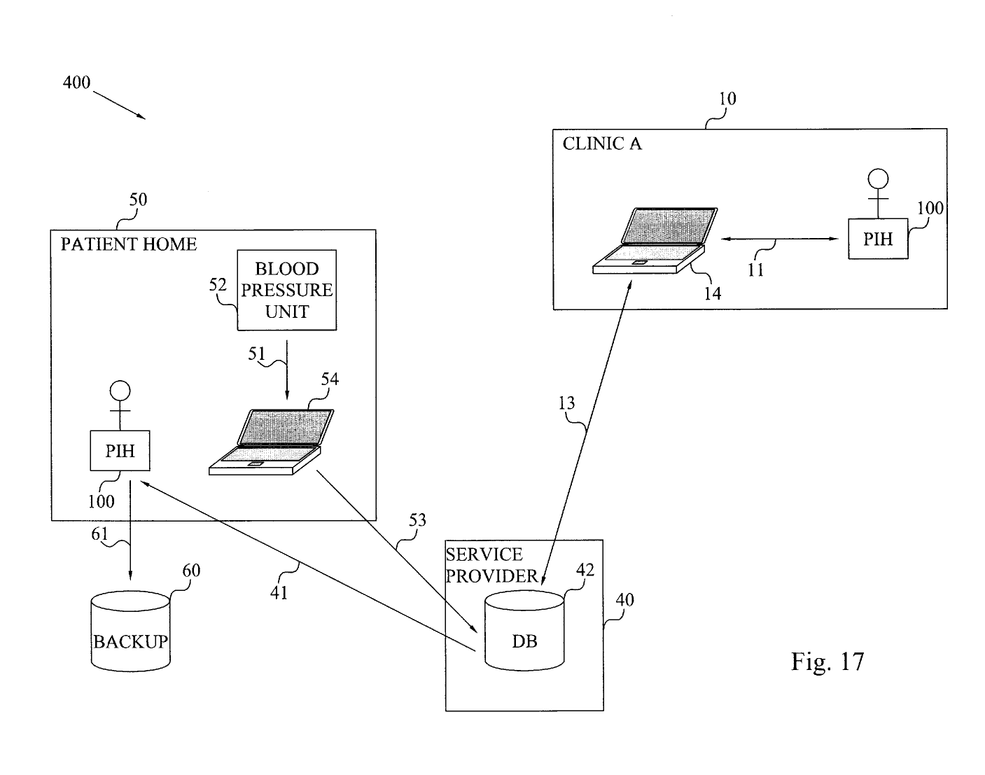

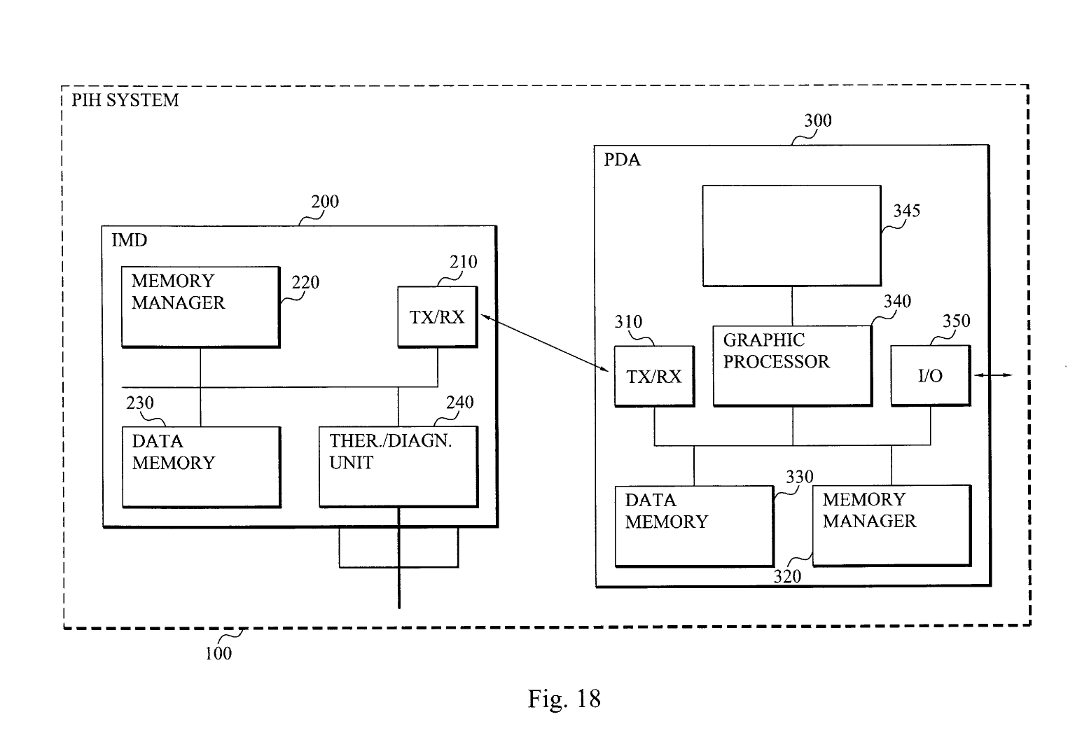

The PIH system of the present invention can also be used in connection with a home hub or monitoring unit that is installed in the patient's home for performing different diagnostic measurements and statistics collections, such as blood pressure and weight measuring. FIG. 17 is a schematic overview of a healthcare system 400 employing a home monitoring unit 54 provided in the IMD patient's home 50 and connected to a blood pressure unit 52. Once the blood pressure unit 52 has performed a pressure measurement it forwards 51 the results to the home hub 54. This home hub 54 has preferably been assigned a document depository 42, typically arranged externally at a service/care provider 40. The hub 54 processes the measurement results and compiles a report, which is uploaded and provided 53 to the depository 42. The depository 42 stores the measurement report in a file assigned to the current patient. In addition, a document registration message is compiled and transmitted 41 over a communications network to the PDA of the PIH system 100. The PIH system 100 updates its document list by making a new entry therein comprising location and name information of the measurement report and any other useful metadata received 41 from the remote depository.

If the patient subsequently visits a physician at a clinic A 10, the physician might want to check if there are any newly registered blood pressure documents for the patient in the healthcare system 400. The physician uses his workstation 14 for querying 11 the PIH system 100 for any such document in the document list. The PIH system 100 provides the list and returns 11 it or information of those documents mentioned in the list and fulfilling the query criteria to the workstation 14. The physician will identify the measurement data previously compiled by the home hub 54 and orders 13 it from the depository 42 using the location information provided 11 from the PIH system 100.

As has been extensively described in the foregoing, the healthcare system 400 can include a back-up database or server 60 in which a back-up copy of the document list in the PIH system 100 is stored as a security measure. The PIH system 100 preferably intermittently, periodically or at scheduled time instances sends 61 a copy of its most updated version of the document list to the back-up database 60.

The patient himself/herself may also produce medical documents, which should be included in his/her medical record. For example, self observation reports, diary entries, symptom description reports, etc. can be compiled using the PDA or a computer in connection with the PDA. The compiled document is then preferably sent to a remote depository assigned for this purpose, such as the depository of the patient's main physician. Alternatively, the document could be stored in the PIH system, which then will function as depository. In either case, the document list managed by the PIH system is updated with this new document.

The PIH system of the present invention is a very flexible tool which significantly will improve the data management and interrogation in a healthcare system. The PIH system can take many different roles that traditionally have assigned to other units in different affinity/patient-identifier domains. Firstly, the PIH system of course is a patient-specific document registry since it stores and manages information of the medical documents generated for the patient/IMD by different document sources throughout the healthcare system. In addition, the PIH system preferably has the role of patient-identifier manager. This means that the PIH system stores and manages the patient identifiers assigned to the patient and used by healthcare providers in different patient-identifier domains in the healthcare system. Furthermore, the PIH system per se can also be a document source since, in particular the IMD part of the PIH, is equipped for performing different diagnostic measurements and data collections. The PDA part of the PIH system could forwards these measurement results for storage as a medical document in a remote depository. However, it is actually possible to store the measurement data in the IMD or PDA of the PIH system. This means that the PIH system can also take the role of document depository for internally generated medical documents but also for other external sources, such as a home hub, if no other document depository has been assigned for the sources. Finally, the patient or physician can actually use the PDA of the PIH system for identifying, retrieving and viewing medical documents of the patient, which means that the PIH system can also be a document consumer. No prior art solutions have been able to provide this flexibility and robustness in a healthcare system.

In addition to the document list, patient identifier list and security attribute managing capabilities mentioned above, the PIH system of the present invention can also include logging functionality. This means that the PIH system would implement an audit depository, where each access of documents listed in the documentation list, request for patient identifiers from the patient identifier list and/or security attribute requests is registered. This function would then solve some issues that might rise in emergency situations, when it is not possible for the patient to authorize the access. By logging these accesses and requests in the PIH system, they can later be traced and evaluated afterwards if necessary.

This means that once the PIH system receives a data (document location, patient identifier, security attribute) requests, it logs this requests in its audit log. This means that such a log entry preferably comprises information of the requested data (document identifier, patient identifier, attribute description), information of the requesting person and preferably time information being descriptive of when the request was made. This log can be stored in the IMD and/or PDA part of the PIH system.

The present invention can also be used as an efficient implementation and manager of the so-called concept Personal Health Records, PHRs. PHR basically involves that the patient have his/her record, as compared to when the doctors and hospitals have the records, typically denoted Electronic Health Records, EMRs, in the art. The prior art PHR solution has been limited to giving the patient printouts of his/her recorded medical images and summaries for home archiving. A next time the patient visits another doctor, he/she should bring these printouts to the doctor so that the doctor can review them in connection with the visit. This is of course far from an optimal solution, since it firstly involves copying vast amount of documentation, especially if a hospital has many patients. In addition, requiring the patient to bring all his/her prior recorded documents is in most cases infeasible due to the large amount of documents that are generated for some patients. In addition, relying on the patient's judgment of which document of his/her whole record to bring to a doctor visit is neither an acceptable solution.

The PIH system of the present invention can efficiently handle PHRs. The PIH system will automate the PHR update, implying that new documents of the patient's medical record will become registered at document list of the PIH system so no actual copying and management of such documents is required. The PIH system can also be used by the patient to, at any time the PIH can be connected to a relevant network, access the documents of his/her medical record. The patient therefore does not have to store and keep all paper documents in order at his/her home. The PIH system also efficiently handles the security problems present for the prior art paper management solution. Furthermore, no sensitive paper documents may actually lie at the patient's home, where they can be read by an unauthorized person, with the PIH solution of the present invention. The PIH also handles access control to the medical documents of the patient. A further important aspect is that the PIH system integrates well with the existing healthcare systems and allows fully implementation of the PHR concept in such systems without the previously mentioned prior art drawbacks and limitations.

FIG. 18 is a block diagram of an embodiment of a PIH system 100 according to the present invention. The PIH system 100 comprises the implantable medical device 200 and a non-implanted communications unit 300, exemplified as a PDA in the figure. The IMD 200 and PDA 300 respectively comprise a communication module 210, 310, such as a transceiver unit 210, 310 (two transmitter-receiver pairs), for conducting mutual communication with each other. The two communications modules 210, 310 communicate with each other via a wireless link. This wireless transmission could generally be realized using any known non-invasive wireless technique usable in medical applications. A preferred example is radio frequency (RF) telemetry, in which radio packets carrying data are transmitted over the wireless link between the IMD 200 and the PDA 300. Other examples of useful wireless transmission techniques are inductive data transmission. In the relevant art, such transmission is generally denoted telemetry so the two communications modules 210, 310 would then be regarded as telemetry units.

The IMD 200 comprises, in addition to its transceiver unit 210, a data memory 230 for storing, in this embodiment, a document list or register. This document list comprises entries containing information of i) medical data documents associated with and generated for the patient or the IMD 200. In addition, the entries include ii) information of in which data depository of the multiple depositories in the healthcare system a medical data document is stored and from where it can be retrieved. Thus, the document list constitutes a collective listing of preferably all medical documents constituting the medical patient record and information where the different documents can be found. As mentioned in the foregoing, the list preferably also includes additional metadata for facilitating identification of a document from the list.

The data memory 230 is managed by a memory manager 220 which is configured for retrieving the document list from the memory 230 based on a communication operation involving the transceiver system 210, 310 implemented in the IMD 200 and the PDA 300. Thus, the transceiver 310 of the PDA 300 typically sends a list request to the transceiver 210 of the IMD 200. The transceiver 210 either forwards the request directly to the manager 220 or processes it to provide a list request in suitable format at the manager 220. The memory manager 220 retrieves a copy of the list from its connected data memory 230 based on this list request and returns it to the IMD transceiver 210 for transmission, preferably securely transmission, to the PDA transceiver 310.

The PDA-implemented part 310 of the transceiver system 210, 310 forwards the list copy to a memory manager 320 of the PDA for temporary storage in a connected data memory or cache 330. The provided list copy can then be communicated to an external unit, from which a general input and output (I/O) unit 350 of the PDA has received a list request. Alternatively, the memory manager 320 includes or has access to a search algorithm that uses a search string received from the I/O unit 350 as input and searches through the entries of the document list in the data memory/cache 330. If the search algorithm identifies one or more document entries in the list, information of these entries are provided to the I/O unit 350 for forwarding to the external requesting unit.

In addition, or alternatively, to forwarding the requested document list (portion), the list or the relevant portion thereof can be presented to a graphic processor 340 of the PDA 300. This graphic processor 340 processes the input data and displays it as graphical information on a connected display screen 345 for review by a user.

It is anticipated by the present invention that other useful data besides the document list can be stored in the PIH system 100, such as the previously mentioned patient identifiers and security attributes. In such a case, these extra data can be found in the same data memory 230 as the document list. Alternatively, at least some of this data can be stored in the data memory 330 arranged in the PDA. This extra data can be retrieved and forwarded by the I/O unit 350 or displayed on the screen 345 in a similar manner to the document list.

The IMD 200 of the PIH system 100 also comprises a therapy and/or diagnostic unit 240 arranged for exerting a defined therapeutic and/or diagnostic function to the patient, in which the IMD 200 is implanted. For example, the unit 240 can include a lead inserted into the patient's heart for collecting diagnostic and physiological data of the condition of the patient's heart, such as IEGM (intracardiac electrogram), ECG (electrocardiogram), electromyography (EMG), electroencephalography (EEG), electrooculography (EOG), event marker, respiration, blood pressure and/or oximetry-related data. This collected diagnostic data can be temporarily or permanently stored in the data memory 230 of the IMD. In the latter case, the memory manager 220 updates the document list in the data memory 230 of these new data and that it is stored in the IMD. In the former case, the data will eventually be uploaded from the IMD 200 to the PDA 300 or some other unit capable of communicating with the IMD 200. The data is then forwarded to a data depository for storage therein. The depository will register and update data to the I/O unit 350 of the PDA 300, which forwards the update information via the transceivers 210, 310 to the memory manager 220 in the IMD. The manager updates the document list in the memory 230 by adding new entries in the list and/or updating current entries based on update information received from the transceiver 210.

Once the I/O unit 350 receives a list query or request from an external communicating unit, information of the requesting unit or its user included in the request or sent separately can be forwarded to the graphic processor 340. The processor 340 alerts the user of the received request by displaying informative data on the display screen 345. The patient can then grant or deny access to information in the document list by activating user inputs (buttons or touch-sensitive screen 345) on the PDA 300. If access is granted the request is processed as previously described. However, no document list will be provided from the data memory 230 if the patient denies the requester access to the list information. In an alternative approach, the memory manager 220, 320 in the IMD 200 or PDA 300 has access to access rights profile with pre-defined assigned access rights to different users in the healthcare system. The manager then determines whether access to information in the document should be granted based on the rights profile and the user identifier received by the I/O unit 350.

The units 210, 220 and 240 of the IMD 200 and 310, 320, 340 and 350 of the PDA 300 can be provided as hardware, software or a combination of hardware and software. As noted in the foregoing, PDA should merely be seen as an illustrative example of suitable non-implanted communications unit of the PIH system of the present invention. This means that other such non-implanted communications units, such as portable PCs, mobile telephones, etc. can be used instead.

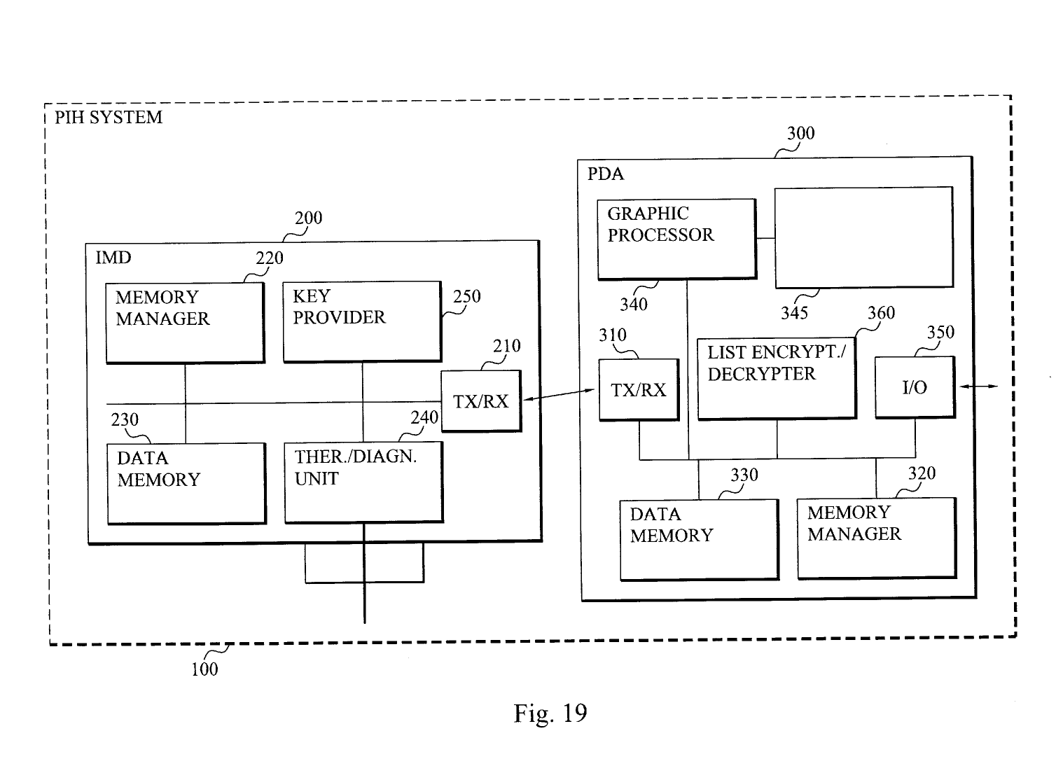

FIG. 19 is a block diagram of another embodiment of the PIH system 100 according to the present invention. The operation of this PIH system embodiment is similar to the embodiment described above in connection with FIG. 18 with one exception. In this embodiment, the document list, or at least a portion thereof, is stored in encoded form in the data memory 330 of the PDA 300. Thus, when the I/O unit 350 receives a list query from an external unit or from the activation of a user input of the PDA 300, a decryption key request is compiled and forwarded to the IMD 200 using the transceiver system 210, 310. This IMD embodiment 200 comprises a key provider 250 that provides the requested decryption key based on the request received by the transceiver 210. In a first embodiment, the key provider 250 is realized as a key storage and a storage manager that retrieves a copy of the decryption key from the storage and forwards it, using the transceivers 210, 310, to a decrypter 360 in the PDA 300. In a second embodiment, the key provider 250 is a key engine that generates the decryption key when required. In either case, the decrypter 360 uses the provided decryption key for decrypting the encrypted document list from the data memory 330. The resulting list in readable form is temporarily and transiently stored in the data memory/cache 330. The list can be displayed on the screen 345 or forwarded to an external unit. The transient readable list is preferably removed from the memory after it has been displayed or a copy/portion thereof has been communicated to the external unit.

The decrypter 360 also performs the list decryption when the document list is to be updated. The resulting updated list is then encrypted by a dedicated list encrypter 360 or a combined list encrypter/decrypter unit 360. The key used for encrypting the data could be the same or different from the decryption key. In either case, the encryption key is preferably available form the key provider 250 in the IMD when needed.

In this embodiment, the data memory 230 and memory manager 220 of the IMD 200 could mainly be used for storing and handling medical data collected by the therapy/diagnostic unit 240. However, the data memory 230 could also be used by the key provider 250 for storage of relevant decryption/encryption keys.

The units 210, 220, 240 and 250 of the IMD 200 and 310, 320, 340, 350 and 360 of the PDA 300 can be provided as hardware, software or a combination of hardware and software.

In the two previously described PIH embodiments, the PDA is equipped with modules for communicating both with the IMD through RF or inductive transmissions/telemetry and for communicating with an external unit, possibly over a radio-based network. The PDA or non-implanted communicating unit used in the PIH system of the present invention can be such a unit manufactured for the purpose of the PIH. Alternatively, any state of the art PDA, mobile telephone or portable laptop can be used as non-implanted communications unit according the present invention. In such a case, the PDA most often has to be complemented with hardware and/or software units for allowing the PDA to (securely) communicate with the IMD. For a software solution, the existing communication equipment, such as antenna, modulator/demodulator, encoder/decoder, of the PDA could be re-used for IMD communication if a software module or program has been installed in the PDA.

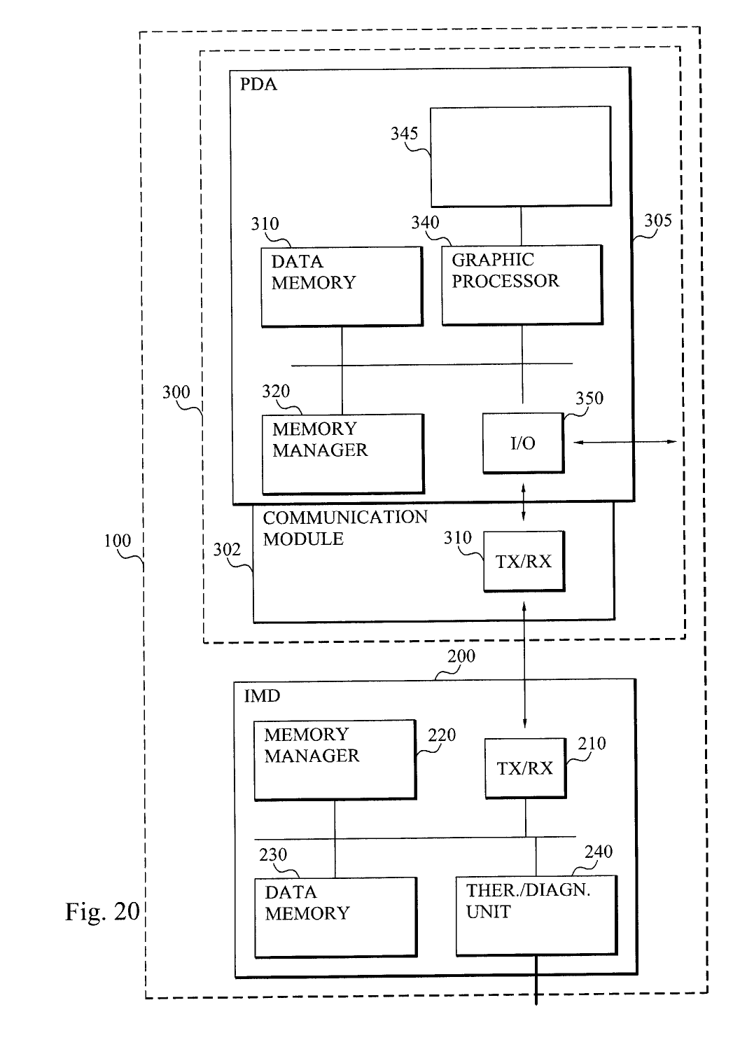

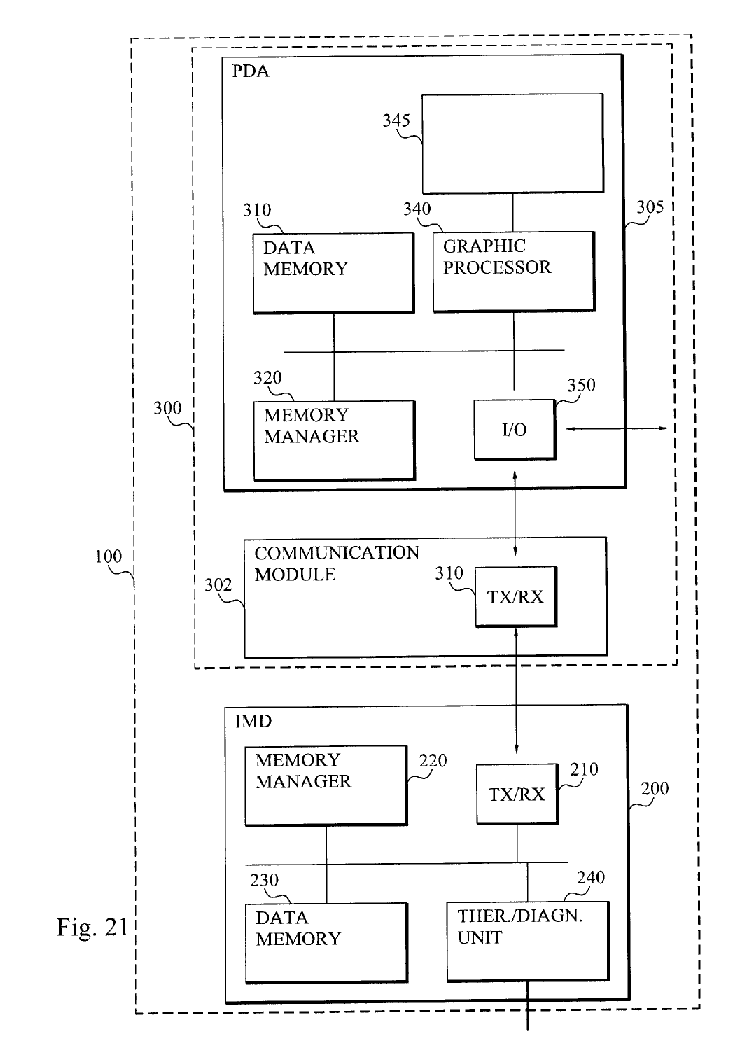

In FIGS. 20 and 21 two alternative approaches have been illustrated. Starting with FIG. 20, the non-implanted communications module 300 comprises in this case the PDA 305 (mobile telephone or portable PC, etc.) with a connected communications module 302. This communications module 302 comprises equipment, illustrated as a transceiver 310 in the figure, for conducting communication with the IMD 200. This transceiver 310 is also in communication or connection with the general I/O unit 350 of the PDA 305. This allows forwarding data from the PDA, using the I/O unit 350, to the transceiver 310 of the communications module 302 and further to the transceiver 210 of the IMD (or the other way around).

The communications module 302 preferably includes units for allowing the transceiver 310 to securely communicate with the IMD transceiver 210. This can be realized by allowing each transceiver 210, 310 to each have access to an identical key of a symmetric key-pair or a private key (own private key) and a public key (the public key of the other transceiver).

In this embodiment, the communications module 302 can be in the form of an extension card, such as compack or flash card, inserted into or otherwise connectable to the PDA 305. As is well known in the art, mobile telephones and PDAs generally include input ports to which different kind of equipment can be connected. The communication module of the present invention may therefore include a connector adapted for connection to such an input port. Correspondingly, for some PDAs and laptops, the communication module 302 can be equipped with an USB connector adapted for insertion in the USB port of the PDA 305.

Instead of having a separate communications module physically connectable to the PDA, FIG. 21 illustrates another possible embodiment of a PIH system 100. In this case, the non-implanted communications unit 300 comprises a separate PDA 305 and a separate communications module 302. Since the PDA 300 and module 302 are physically separated, they communicate wirelessly. In this context, RF-based, BLUETOOTH® and IR-based communication are preferred, but non-limiting, examples of communication techniques useful for data transmission between the transceiver 310 and the I/O unit 350.

Correspondingly to the wireless data transmission between the module 302 and the IMD 200, the data transmission between the module 302 and the PDA is preferably performed in a secure manner, e.g. by using encryption keys as previously described.

The operation of the remaining units of the PIH systems illustrated in FIGS. 20 and 21 are similar to what has been described in connection with FIGS. 18 and 19 and is not repeated herein.

The different embodiments of the PIH system described and disclosed in the foregoing may be combined. For example, the document list may be partly stored in the IMD (as disclosed by FIG. 18) and partly stored in encrypted form in the PDA (as disclosed by FIG. 19).

FIG. 22 is a block diagram of an IMD 200 adapted for implantation in a patient. This IMD 200 could generally be any IMD that can communicate with the non-implanted communications unit of the PIH system by means of wireless transmissions. Typical non-limiting examples of an IMD 200 according to the invention include a pacemaker, implantable defibrillator or implantable cardioverter. Further examples include a drug pump, a neurological stimulator, a physical signal recorder, an oxygen sensor, or the like.

The IMD 200 comprises a transceiver 210 adapted for performing the wireless communication from the non-implanted unit and particularly for receiving list requests or encryption/decryption key requests, update information and security attribute requests from the non-implanted communications unit and for transmitting document list, encryption/decryption key, back-up copy of document list and security attributes to the non-implanted unit.

The IMD 200 further includes the data memory 230 configured, in a first embodiment, for storing the document list of the patient and the memory manager 220 for entering and retrieving data in/from the memory 230. This memory manager 220 is in particular implemented for retrieving the document from the data memory 230 based on a performed communication operation involving the transceiver 210 and the non-implanted communications unit, i.e. transmission of a list request therebetween. The retrieved document list is then forwarded by the transceiver 210 to the non-implanted unit.

In a preferred implementation, the IMD 200 may also contain an attribute provider 260. This attribute provider 260 is arranged for providing security attributes needed by the patient and/or physicians for the management of medical documents of the patient in the healthcare system. For example, the attribute provider 260 can manage security credentials (user name and/or password) needed when logging in to remote data depositories for the purpose of retrieving medical data documents therefrom. In addition, or alternatively, the provider 260 can handle CA tokens and other authentication data useful when authenticating communicating units in the healthcare system, such as IMD-PDA authentication, PDA-external unit authentication, PDA-depository authentication and physician's workstation-depository authentication.

The attribute provider 260 may have access to an attribute store, such as the data memory 230 or a dedicated storage, where the security attributes are kept. Once the transceiver 210 receives a request for a security attribute, the request is forwarded to the provider 260, which identifies the requested attribute and returns it or a copy thereof to the transceiver 210.

In an alternative embodiment, the attribute provider 260 is or comprises an attribute engine or generator 265, such as the key engine illustrated in FIG. 20. In this solution, the provider 260 or engine 265 generates the attribute/key on the fly when requested.

The units 210, 220, 240, 260 and 265 of the IMD 200 can be provided as hardware, software or a combination of hardware and software.

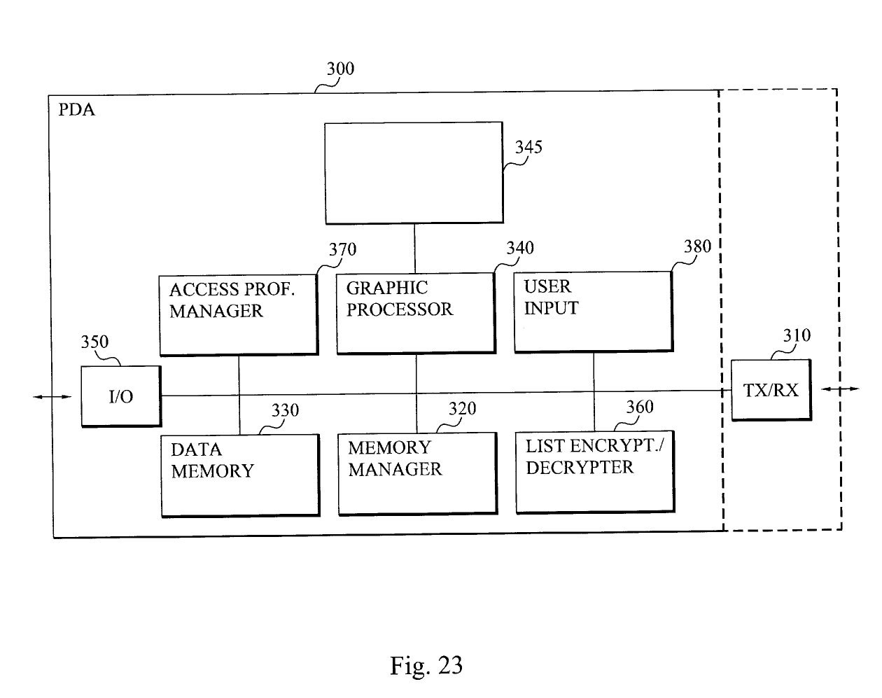

FIG. 23 is a corresponding block diagram of an embodiment of a non-implanted communications unit 300 of the PIH system, represented as a PDA in the figure. The PDA comprises the I/O unit 350 for conducting communication with external units and for receiving inputs signals from touch sensitive screens 345, buttons or other user inputs 380 of the PDA 300. The operation of the data memory 330, memory manager 320, list encrypter/decrypter 360 and graphic processor 340 is similar to corresponding units described above in connection with FIGS. 18 and 19 and is not repeated herein.

The PDA 300 may also include an access profile manager 370 having a rights profile defining access rights of users in the healthcare system to information stored in the document list managed by the PIX system. This manager 370 preferably receives, from the I/O unit 350, an identifier of a user requesting the document list. This identifier can be notified in the list request message, in a separate message or be deduced from an authentication procedure involving the PDA 300 and the requesting external unit. In either case, the manager 370 investigates whether the identifier is found in the list or not. In the latter case, he/she is not authorized to get a copy of the list. In this case, therefore no list information or merely a denial message can be compiled and returned by the I/O unit 350. The manager 370 may, however, also be configured for forwarding the identifier to the processor 340 for display on the screen 345. In such a case, the patient having the PIH system can be informed of the requesting user and might possible overrule the denial as determined from the profile, by activating a user input 380. As previously described, different levels of access rights can be employed in the rights profile.

The transceiver 310 used for communicating with the IMD can form an integral part of the PDA 300, be included in a module connectable to or implemented in the PDA 300 or be included in a separate module wirelessly communicating with the I/O unit 350.

The units 310, 320, 340, 350, 360, 370 and 380 of the non-implanted communications unit 300 can be provided as hardware, software or a combination of hardware and software.

Although modifications and changes may be suggested by those skilled in the art, it is the intention of the inventors to embody within the patent warranted heron all changes and modifications as reasonably and properly come within the scope of their contribution to the art.

1. A data management method in a healthcare system comprising multiple data depositories storing medical data documents associated with at least one of i) a patient having an implantable medical device and ii) said implantable medical device, characterized by:
storing a list in a memory of a patient information hub system comprising said implantable medical device and a non-implanted communications unit configured to conduct data communication with said implantable medical device and formulating said list to comprise, for each of said medical data documents, information of the data depository of said multiple data depositories that stores the medical data document;
said patient information hub system receiving a request for said list; and
said patient information hub system retrieving said list from said memory based on a communication operation involving said implantable medical device and said communications unit.

2. The method according to claim 1, comprising formulating said information to comprise an Universal Resource Identifier from which said medical data document can be accessed.

3. The method according to claim 1 comprising formulating said list to further comprise, for each of said medical data documents, metadata being descriptive of said medical data document and facilitating identification of said medical data document from said list.

4. The method according to claim 1 comprising said non-implanted communications unit displaying, on a display screen of said non-implanted communications unit, information contained in said retrieved list.

5. The method according to claim 1 comprising said non-implanted communications unit forwarding said retrieved list to an external workstation, from which said request for said list originated.

6. The method according to claim 1, comprising, in said communication operation, transmitting data from said non-implanted communications unit to said implantable medical device.

7. The method according claim 1 comprising implementing said memory at least partly in said implantable medical device and wherein said receiving step comprises the steps of:
said non-implanted communications unit receiving said request;
said non-implanted communications unit forwarding, to said implantable medical device, said request, and wherein said retrieving step comprises the steps of:
said implantable medical device retrieving said list from said memory based on said request; and
said implantable medical device transmitting said list to said non-implanted communications unit.

8. The method according to claim 1 comprising implementing said memory at least partly in said non-implanted communications unit and storing said list in an encrypted form in said memory and wherein said receiving step comprises the steps of:
said non-implanted communications unit receiving said request; and
said non-implanted communications unit transmitting, to said implantable medical device, a request for a decryption key, and said retrieving step comprises the steps of:
said implantable medical device transmitting said requested decryption key to said non-implanted communications unit (300) based on said request; and
said non-implanted communications unit decrypting said encrypted list to provide said list in readable transient form.

9. The method according to claim 8, comprising:
said non-implanted communications unit temporarily storing said list in readable transient form in a memory; and
said non-implanted communications unit removing said list in readable transient form said memory in connection with ending a current data management session.

10. The method according to claim 1, comprising arranging said multiple data depositories respectively in different patient-identifier domains in said healthcare system, each patient-identifier domain having an assigned identifier of said patient, and a memory of said patient information hub system storing a list of patient identifiers assigned to said patient and used by said different patient-identifier domains.

11. The method according to claim 1 comprising:
said patient information hub system receiving update information of a new medical data document associated with at least one of said patient and said implantable medical device and stored in a data depository; and
said patient information hub system updating said list based on said received update information.

12. The method according to claim 1, comprising providing said patient information hub system with an access profile defining medical data access rights to said medical data documents associated with at least one of said patient and said implantable medical device for different users in said healthcare system, and wherein said retrieving step comprises said patient information hub system retrieving said list from said memory based on said communication operation and based on said access profile.

13. The method according to claim 1, comprising:
said non-implanted communications unit displaying, based on reception of said request for said list, information of a user from whom said request for said list originates on a display screen of said non-implanted communications unit; and
said non-implanted communications unit generating an access grant signal in response to said patient activating a granting user input of said non-implanted communications unit, and wherein said retrieving step comprises said patient information hub system retrieving said list from said memory based on said communication operation and based on said access grant signal.

14. The method according to claim 1 comprising, via a security provider in said implantable medical device, providing security attributes for accessing said multiple data depositories and said method further comprising:
said patient information hub system receiving an attribute request for a security attribute for accessing a data depository of said multiple data depositories; and
said security credential provider providing said requested attribute credential based on said credential request.

15. The method according to claim 1, comprising said non-implanted communications unit securely transmitting a back-up copy of said list to an external secure database.

16. in a patient information hub system comprising an implantable medical device implanted in a patient and a non-implanted communications unit adapted for conducting data communication with said implantable medical device, the improvement comprising:
a memory in which a list is stored comprising information of i) medical data documents associated with at least one of said patient and said implantable medical device and ii) information of, for each of said medical data document, the data depository of multiple data depositories in a healthcare system that stores the medical data document;
a transceiver system implemented in said implantable medical device and said non-implanted communications unit that conducts a communication operation involving said implantable medical device and said non-implanted communications unit; and
a memory manager that retrieves said list from said memory based on said communication operation.

17. The system according to claim 16, wherein said non-implanted communications unit comprises a request input that receives a request for said list and said transceiver system configured to perform said communication operation based on said request input receiving said request.

18. The system according to claim 16, wherein said non-implanted communications unit comprises:
a display screen; and
a graphical processor that displays, on said display screen, information contained in said retrieved list.

19. The system according to claim 16 wherein said non-implanted communications unit comprises an output that forwards said retrieved list to an external workstation, from which said request for said list originated.

20. The system according to claim 16 wherein said transceiver system comprises:
a first transceiver implemented in said non-implanted communications unit; and
a second transceiver implemented in said implanted medical device, said first transceiver and said second transceiver being configured to conduct said communication operation by transmitting data from said first transceiver to said second transceiver.

21. The system according to claim 20, wherein said non-implanted communications unit comprises a communications module and a data processing module, said first transceiver being implemented in said communications module and said transceiver system further comprises a third transceiver implemented in said data processing module and being configured to conduct communication with said first transceiver, said first transceiver, said second transceiver and said third transceiver being configured to conduct said communication operation by transmitting data from said third transceiver to said first transceiver and from said first transceiver to said second transceiver.

22. The system according to claim 20 wherein said memory and said memory manager are at least partly implemented in said implantable medical device, said first transceiver being configured to forward, to said second transceiver, said request for said list, said memory manager being configured to retrieve said list from said memory based on said second transceiver receiving said request, and second transceiver being configured to transmit said retrieved list to said first transceiver.

23. The system according to claim 20 wherein said memory and said memory manager are at least partly implemented in said non-implanted communications unit and said list is stored in an encrypted form in said memory, said first transceiver being configured to transmit, to said second transceiver, a request for a decryption key, said second transceiver configured to transmit, to said first transceiver, said decryption key based on said key request and said non-implanted communications unit comprises a decrypter for decrypting, based on said decryption key, said encrypted list to provide said list in readable transient form.

24. The system according to claim 23, wherein said memory manager is configured to temporarily store said list in readable transient form in a memory and to remove said list in readable transient form said memory in connection with ending a current data management session.

25. The system according to claim 16 wherein said multiple data depositories are arranged in different patient-identifier domains in said healthcare system each patient-identifier domain having an assigned identifier of said patient, and wherein said patient information hub system further comprises a memory for storing a list of patient identifiers assigned to said patient and used by said different patient-identifier domains.

26. The system according to claim 16 comprising
an update input that receives update information of a new medical data document associated with at least one of said patient and said implantable medical device stored in a data depository; and
a list updater for updating said list based on said received update information.

27. The system according to claim 16 comprising an access profile, provided in said patient information hub system, defining medical data access rights to said medical data documents associated with at least one of said patient and said implantable medical device for different users in said healthcare system and wherein said memory manager is configured to retrieve said list from said memory based on said communication operation and based on said access profile.

28. The system according to claim 16 wherein said non-implanted communication unit comprises:
a display screen;
a graphical processor that displays, in response to reception of a request for said list and on said display screen, information of a user from whom said request for said list originates; and
a granting user input that generates, when activated by said patient, an access grant signal, and wherein said memory manager is configured to retrieve said list from said memory based on said communication operation and based on said access grant signal.

29. The system according to claim 16 wherein said patient information hub system comprises a request input that receives an attribute request for security attributes for accessing a data depository of said multiple data depositories, and said implantable medical device comprises a security attribute provider that provides, based on said attribute request, a security attribute for accessing said data depository.

30. The system according to claim 16 wherein said non-implanted communications unit comprises a transmitter that transmits a back-up copy of said list to an external secure database.

31. A healthcare system comprising:
multiple data depositories in which medical data documents are stored that are associated with at least one of i) a patient having an implantable medical device and ii) said implantable medical device;
a workstation; and
a patient information hub system comprising:
said implantable medical device;
a non-implanted communications unit configured to conduct data communication with said implantable medical device;
a memory that stores a list comprising, for each of said medical data documents, information of the data depository of said multiple data depositories that stores the medical data document;
a request input that receives, from said workstation, a request for said list;
a transceiver system implemented in said implantable medical device and said non-implanted communications unit that conducts, based on said request input receiving said request, a communication operation involving said implantable medical device and said non-implanted communications unit; and
a memory manager that retrieves said list from said memory based on said communication operation; and
a list output that forwards, to said workstation, said list retrieved by said memory manager.

32. An implantable medical device adapted for implantation in a patient (1), characterized by:
a memory in which a list is stored comprising information of i) medical data documents associated with at least one of said patient and said implantable medical device and ii) information of, for each of said medical data document, the data depository of multiple data depositories in a healthcare system that stores the medical data document;
a transceiver that conducts a communication operation with a non-implanted communications unit;
a memory manager that retrieves said list from said memory based on said communication operation.

33. A non-implanted communications unit configured to conduct communication with an implantable medical device implanted in a patient comprising:
a memory in which an encrypted representation of a list is stored comprising information of i) medical data documents associated with at least one of said patient and said implantable medical device and ii) information of, for each of said medical data document, the data depository of multiple data depositories in a healthcare system that stores the medical data document;
a request input that receives a request for said list;
a transmitter that requests a decryption key from said implantable medical device in response to said request input received said list request;
a receiver that receives said decryption key from said implantable medical device;
a decrypter that decrypts said list representation based on said decryption key; and
a memory manager that retrieves said decrypted list from said memory.
